(19) United States
(12) Patent Application Publication
(10) Pub. No.: US 2013/0029075 A1
(43) Pub. Date: Jan. 31, 2013

(54) TRANSPARENT PLATE HAVING ADHESIVE LAYER, DISPLAY DEVICE AND PROCESSES FOR THEIR PRODUCTION

(71) Applicant: ASAHI GLASS COMPANY, LIMITED, Tokyo (JP)

(72) Inventors: Satoshi Niiyama, Tokyo (JP); Naoko Aoki, Tokyo (JP); Hiroshige Ito, Tokyo (JP); Hitoshi Tsushima, Tokyo (JP); Satoru Takagi, Tokyo (JP)

(73) Assignee: ASAHI GLASS COMPANY, LIMITED, Tokyo (JP)

(21) Appl. No.: 13/646,903

(22) Filed: Oct. 8, 2012

Related U.S. Application Data
(63) Continuation of application No. PCT/JP11/62018, filed on May 25, 2011.

(30) Foreign Application Priority Data
May 26, 2010 (JP) 2010-120669
Aug. 19, 2010 (JP) 2010-184081
Aug. 19, 2010 (JP) 2010-184082

(51) Int. Cl. B32B 3/02; C09J 7/02; B32B 7/12; B32B 37/12; B32B 38/10

(52) U.S. Cl. 428/41.7; 156/60; 156/247; 428/192; 428/172

(57) ABSTRACT

To provide a transparent plate having an adhesive layer, wherein voids are less likely to remain at the interface between the adhesive layer and another plate; a display device, wherein formation of voids at the interface between the display panel and the adhesive layer and at the interface between the transparent plate and the adhesive layer, is sufficiently prevented; and processes for their production. A transparent plate having an adhesive layer, which comprises a protective plate (a transparent plate) and an adhesive layer formed on a surface of the protective plate, wherein the adhesive layer comprises a layer portion spreading over the surface of the protective plate and a seal portion enclosing the periphery of the layer portion; a display device having the transparent plate bonded; and processes for their production.

### TECHNICAL FIELD

The present invention relates to a transparent plate having an adhesive layer, a display device having a display panel protected by the transparent plate, and processes for their production.

### BACKGROUND ART

As a method for producing a display device having a display panel protected by a transparent plate (protective plate), the following method is known.

A method of bonding a display panel and a protective plate via an adhesive sheet (Patent Documents 1 and 2).

However, such a method has the following problems.

(1) An operation to cut the adhesive sheet in conformity with the size of the display panel or the protective plate, is required.

(2) It is difficult to cut the adhesive sheet with good dimensional precision, since the adhesive sheet has a low elastic modulus.

(3) It is necessary to bond an adhesive sheet to either one plate of the display panel and the protective plate and then bond the remaining plate to the adhesive sheet, i.e. since two steps of bonding are required, bonding of the display panel and the protective plate is cumbersome.

(4) At the time of bonding the adhesive sheet to either one plate of the display panel and the protective plate, voids (air bubbles) are likely to remain at the interface between the plate and the adhesive sheet.

(5) At the time of bonding the adhesive sheet to either one plate of the display panel as the protective plate and then bonding the remaining plate to the adhesive sheet, voids (air bubbles) are likely to remain also at the interface between the remaining plate and the adhesive sheet.

### PRIOR ART DOCUMENTS

### Patent Documents

Patent Document 1: JP-A-2006-290960

Patent Document 2: JP-A-2009-263502

### DISCLOSURE OF INVENTION

### Technical Problem

The present invention is to provide a transparent plate having an adhesive layer, whereby bonding of the transparent plate (protective plate) to another plate (such as a display panel) is easy, and when it is bonded to another plate, voids are less likely to remain at the interface between the adhesive layer and another plate; a transparent plate having an adhesive layer, whereby formation of voids at the interface between the transparent plate and the adhesive layer is sufficiently prevented, bonding to another plate (such as a display panel) is simple, and it is not required to cut the adhesive layer in conformity with the size of another plate; a process for producing a transparent plate having an adhesive layer, whereby formation of voids at the interface between the transparent plate and the adhesive layer is sufficiently prevented, bonding to another plate is simple, and it is not required to cut the adhesive layer in conformity with the size of another plate; a display device, whereby formation of voids is sufficiently prevented at the interface between the display panel and the adhesive layer and at the interface between the transparent plate and the adhesive layer; and a process for producing a display device, whereby bonding of the transparent plate and the display panel is simple, voids are less likely to remain at the interface between the display panel and the adhesive layer and at the interface between the transparent plate and the adhesive layer, and it is not required to cut the adhesive layer in conformity with the size of the display panel.

### Solution to Problem

The transparent plate having an adhesive layer of the present invention is a transparent plate having an adhesive layer, which comprises a transparent plate and an adhesive layer formed on at least one surface of the transparent plate, wherein the adhesive layer comprises a layer portion spreading over the surface of the transparent plate and a seal portion enclosing the periphery of the layer portion.

At least at a part of a region where the seal portion is adjacent to the layer portion, the thickness of the seal portion is preferably thicker than the thickness of the layer.

The region where the seal portion is adjacent to the layer portion, is preferably a region constituted by the layer portion within the same length as the thickness of the seal portion in a direction parallel to the surface of the transparent plate and vertical to the longitudinal direction of the seal portion, from the plane where the seal portion is in contact with the layer portion.

The shearing modulus of the layer portion at 25° C. is preferably from 10³ to 10⁷ Pa.

The shearing modulus of the seal portion at 25° C. is preferably larger than the shearing modulus of the layer portion at 25° C.

The transparent plate is preferably a protective plate for a display device.

The transparent plate having an adhesive layer of the present invention preferably further has a strippable protective film covering the surface of the adhesive layer.

A display device of the present invention comprises a display panel, and the transparent plate having an adhesive layer of the present invention which is bonded to the display panel so that the adhesive layer is in contact with the display panel.

The process for producing the display device of the present invention comprises laminating and bonding the display panel and the transparent plate having an adhesive layer of the present invention so that the adhesive layer is in contact with the display panel, in a reduced pressure atmosphere of at most 1 kPa.

The process for producing a transparent plate having an adhesive layer of the present invention is a process for producing a transparent plate having an adhesive layer which comprises a transparent plate, an adhesive layer formed on at least one surface of the transparent plate, and a strippable protective film covering the adhesive layer, wherein the adhesive layer comprises a layer portion spreading over the surface of the transparent plate and a seal portion enclosing the periphery of the layer portion, said process comprising the following steps (a) to (e):

(a) a step of applying a liquid seal portion-forming curable resin composition along the periphery of the surface of a transparent plate to form a seal portion,

(b) a step of supplying a liquid layer portion-forming curable resin composition to a region enclosed by the seal portion,

(c) a step of laminating a support plate having a protective film bonded thereto, on the layer portion-forming curable resin composition, in a reduced pressure atmosphere of at most 1 kPa, so that the protective film is in contact with the layer portion-forming curable resin composition, thereby to obtain a laminated member having an uncured layer portion made of the layer portion-forming curable resin composition hermetically sealed by the transparent plate, the protective film and the seal portion,

(d) a step of curing the uncured layer portion in such a state that the laminated member is placed in a pressure atmosphere of at least 50 kPa, to form an adhesive layer comprising the layer portion and the seal portion, and

(e) a step of releasing the support plate from the protective film.

The viscosity of the seal portion-forming curable resin composition in an uncured state is preferably at least 10 times the viscosity of the layer portion-forming curable resin composition in an uncured state.

The layer portion-forming curable resin composition preferably contains a chain transfer agent.

### Advantageous Effects of Invention

The transparent plate having an adhesive layer of the present invention is simple in bonding to another plate (such as a display panel), and when it is bonded to another plate, voids are less likely to remain at the interface between the adhesive layer and another plate.

According to the process for producing a display device of the present invention, bonding of a display panel and a transparent plate (a protective plate) is simple, and voids are less likely to remain at the interface between the display panel and the adhesive layer.

By the transparent plate having an adhesive layer of the present invention, formation of voids at the interface between the transparent plate and the adhesive layer can be sufficiently prevented, bonding to another plate (such as a display panel) is simple, and it is not required to cut the adhesive layer in conformity with the size of another plate.

According to the process for producing a transparent plate having an adhesive layer of the present invention, it is possible to produce a transparent plate having an adhesive layer, whereby formation of voids at the interface between the transparent plate and the adhesive layer is sufficiently prevented, bonding to another plate is simple, and it is not required to cut the adhesive layer in conformity with the size of another plate.

The display device of the present invention will be one, whereby formation of voids at the interface between the display panel and the adhesive layer and at the interface between the transparent plate and the adhesive layer, is sufficiently prevented.

According to the process for producing a display device of the present invention, bonding of a display panel and a transparent plate (a protective plate) is simple, voids are less likely to remain at the interface between the display panel and the adhesive layer and at the interface between the transparent plate and the adhesive layer, and it is not required to cut the adhesive layer in conformity with the size of the display panel.

### BRIEF DESCRIPTION OF DRAWINGS

FIG. 1 is a cross-sectional view illustrating an example of the transparent plate having an adhesive layer of the present invention.

FIG. 2A is a typical enlarged cross-sectional view of the vicinity of the periphery of the adhesive layer in the transparent plate having an adhesive layer in FIG. 1 having the protective film removed.

FIG. 2B is a typical enlarged cross-sectional view of the vicinity of the periphery of the adhesive layer in another embodiment of the transparent plate having an adhesive layer in FIG. 1 having the protective film removed.

FIG. 3 is a plan view illustrating an example of the state of step (a).

FIG. 4 is a cross-sectional view illustrating an example of the state of step (a).

FIG. 5 is a plan view illustrating an example of the state of step (b).

FIG. 6 is a cross-sectional view illustrating an example of the state of step (b).

FIG. 7 is a cross-sectional view illustrating an example of the state of step (c).

FIG. 8 is a cross-sectional view illustrating an example of the display device of the present invention.

FIG. 9 is a perspective view illustrating the state of a void at the interface between a display panel and an adhesive layer at the time when the transparent plate having the adhesive layer of the present invention and the display panel are bonded.

FIG. 10 is a perspective view illustrating the state of a void at the interface between a display panel and an adhesive sheet at the time when a protective plate and the display panel are bonded via the adhesive sheet.

FIG. 11 is a perspective view illustrating the state of a void at the interface between a display panel and an adhesive sheet at the time when a protective plate and the display panel are bonded via the adhesive sheet.

### DESCRIPTION OF EMBODIMENTS

In this specification, “transparent” means such a state that after a plate and a display surface of a display panel are bonded via an adhesive layer without any void space, the entirety or a part of a display image of the display panel is visible through the plate without receiving an optical distortion. Therefore, even in a case where a part of light entering into the plate from the display panel is absorbed or reflected by the plate, or the visible light transmittance of the plate is low due to e.g. a change in the optical phase, so long as a display image of a display panel is visible through the plate without an optical distortion, the plate can be regarded as “transparent”. The term “(meth)acrylate” means an acrylate or a methacrylate.

<Transparent plate having adhesive layer>

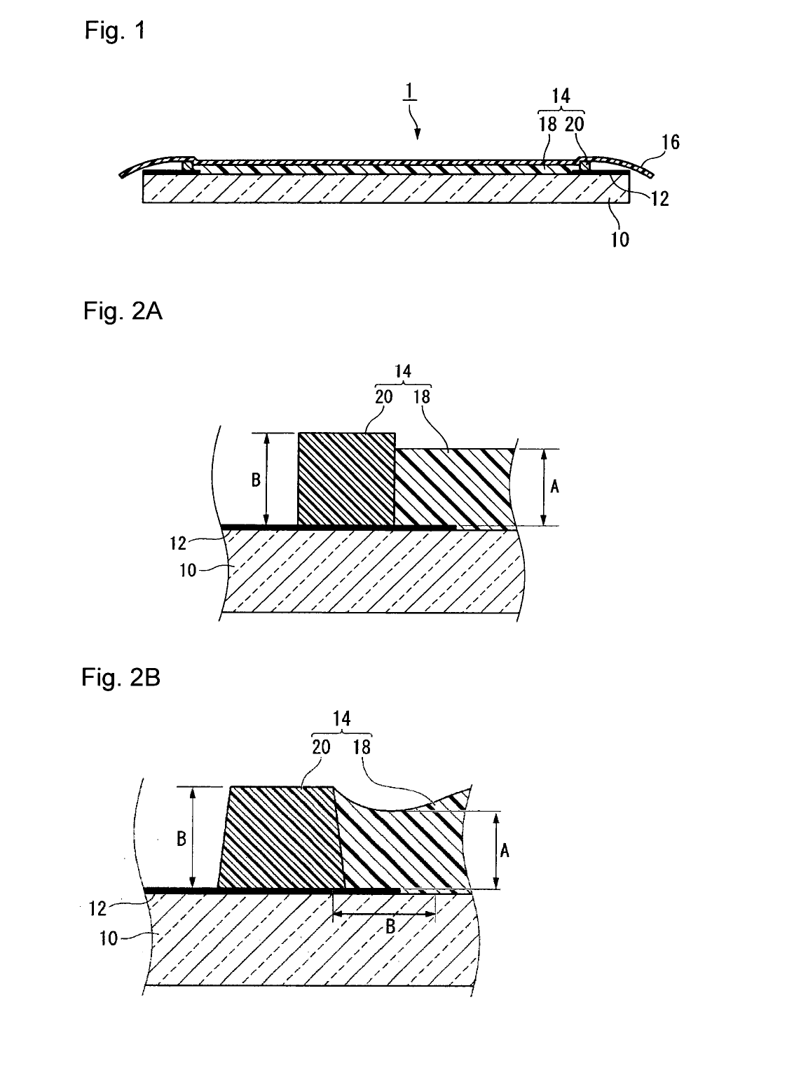

FIG. 1 is a cross-sectional view illustrating an example of the transparent plate having an adhesive layer of the present invention.

The transparent plate 1 having an adhesive layer comprises a protective plate 10 (a transparent plate), a light-shielding printed part 12 formed along the periphery of a surface of the protective plate 10, an adhesive layer 14 formed on the surface of the protective plate 10 having the light-shielding printed part 12 formed thereon, and a strippable protective film 16 covering the surface of the adhesive layer 14.

Here, the transparent plate having an adhesive layer of the present invention plays a role as a precursor of a display device, since after removing the protective film, it is bonded to a display panel to produce a display device.

### (Protective Plate)

The protective plate 10 is to protect a display panel, as provided on an image display side of the after-described display panel.

As the protective plate 10, a glass plate or a transparent resin plate may be mentioned, and a glass plate is most preferred not only from such a viewpoint that the transparency is high to outgoing light or reflected light from a display panel, but also from such a viewpoint that it has light resistance, low birefringence, high flatness, scratch resistance and high mechanical strength. A glass plate is preferred also from such a viewpoint that it sufficiently transmits light to cure a photocurable resin composition.

As the material for such a glass plate, a glass material such as soda lime glass may be mentioned, and less bluish high transmission glass having a less iron content (white plate glass) is more preferred. In order to increase the safety, tempered glass may be used as the front plate. Especially when a thin glass plate is to be used, it is preferred to employ a chemically tempered glass plate.

As the material for the transparent resin plate, a highly transparent resin material (such as a polycarbonate or a polymethyl methacrylate) may be mentioned.

To the protective plate 10, surface treatment may be applied in order to improve the interface bonding strength with the adhesive layer 14. The method for such surface treatment may, for example, be a method of treating the surface of the protective plate 10 with a silane coupling agent, or a method of forming a thin film of silicon oxide by an oxidizing flame by means of a flame burner.

To the protective plate 10, an antireflection layer may be formed on the surface on the side opposite to the side on which the adhesive layer 14 is formed in order to improve the contrast of a display image. Such an antireflection layer may be formed by a method wherein an inorganic thin film is formed directly on the surface of the protective plate 10, or a method wherein a transparent resin film provided with an antireflection layer is bonded to the protective plate 10.

Further, depending upon the purpose, a part or whole of the protective plate 10 may be colored, a part or whole of the surface of the protective plate 10 may be made to be frosted glass to scatter light, or fine irregularities, etc. may be formed on a part or whole of the surface of the protective plate 10 to refract or reflect transmitted light. Otherwise, a colored film, a light-scattering film, a photorefractive film, a light reflective film or the like, may be bonded to a part or whole of the surface of the protective plate 10.

The shape of the protective plate 10 is usually rectangular.

The size of the protective plate 10, is, in the case of a television receiver, suitably at least 0.5 m×0.4 m, particularly preferably from 0.7 m×0.4 m, since the process of the present invention is particularly suitable for the production of a transparent plate 1 having an adhesive layer, having a relatively large area. The upper limit in the size of the protective plate 10 is determined by the size of the display panel in many cases. Further, if the display device is too large, handling in its installation, etc. tends to be difficult. The upper limit in the size of the protective plate 10 is usually at a level of 2.5 m×1.5 m from such restrictions.

The thickness of the protective plate 10 is usually from 0.5 to 25 mm in the case of a glass plate, from the viewpoint of the mechanical strength, transparency, etc. In an application to e.g. a television receiver to be used outdoors or a display for PC, it is preferably from 1 to 6 mm with a view to reducing the weight of the display device, and it is preferably from 3 to 20 mm in an application to a public display to be installed outdoors. In a case where chemically tempered glass is to be used, the thickness of the glass is preferably from about 0.5 to 1.5 mm from the viewpoint of the strength. In the case of a transparent resin plate, the thickness is preferably from 2 to 10 mm.

### (Light-Shielding Printed Part)

The light-shielding printed part 12 is one to shield e.g. a wiring member connected to the display panel, so that other than the after-described image display region of the display panel is not visible from the protective plate 10 side. The light shielding printed part 12 may be formed on the surface on the side where the adhesive layer 14 is to be formed or on the side opposite thereto but with a view to reducing the parallax between the light-shielding printed part 12 and the image display region, it is preferably formed on the surface on the side where the adhesive layer 14 is to be formed. In a case where the protective plate 10 is a glass plate, it is preferred to adopt ceramic printing containing a black pigment in the light-shielding printed part 12, whereby the light-shielding property will be high. In a case where the light-shielding printed part is formed on the side opposite to the side where the adhesive layer is formed, it may be formed also by bonding to the protective plate a transparent film having a light-shielding printed part preliminarily provided. A light-shielding printed part may be provided along the periphery of a transparent film on the side to be bonded to the protective plate, and on its rear side i.e. on the outermost surface of a display device, an antireflective layer may be provided, and such a film may be bonded to the protective plate.

### (Adhesive Layer)

The adhesive layer 14 comprises a layer portion 18 spreading over the surface of the protective plate 10 and a seal portion 20 enclosing the periphery of the layer portion 18 in contact with the periphery. As the adhesive layer 14 has the seal portion 20, it is possible to prevent the periphery of the layer portion 18 from spreading outside i.e. to prevent thickness reduction of the periphery, whereby the thickness of the entire layer portion 18 can be maintained to be uniform. By making the thickness of the entire layer portion to be uniform, it becomes easy to prevent voids from remaining at the interface in bonding with another plate, such being desirable.

In the adhesive layer 14, the thickness of the seal portion 20 can be made thicker than the thickness A of the layer portion 18, as shown in FIG. 2A. Further, at least at a part of a region where the seal portion 20 is adjacent to the layer portion 18, the thickness B of the seal portion is preferably thicker than the thickness A of the layer portion. For example, as shown in FIG. 2B, at least at a part of a region constituted by the layer portion within the same length B as the thickness B of the seal portion 20 in a direction parallel to the surface of the transparent plate 10 and vertical to the longitudinal direction of the seal portion 20, from the plane where the seal portion 20 is in contact with the layer portion 18, the thickness B of the seal portion is preferably thicker than the thickness A of the layer portion. The merits of the thickness B of the seal portion 20 being thicker than the thickness A of the layer portion 18, are as follows.

Bonding of a display panel and a protective plate by a conventional adhesive sheet may be carried out by the following method so that voids will not remain at the interface between the adhesive sheet and the display panel or the protective plate.

A method wherein a display panel and a protective plate are bonded via an adhesive sheet in a reduced pressure atmosphere, and then returned to the atmospheric pressure atmosphere.

By such a method, as shown in FIG. 10, even if an independent void 110 remains at the interface between an adhesive sheet 100 and a display panel 50 or a protective plate 10 at the time of bonding the display panel 50 and the protective plate 10 via the adhesive sheet 100 in a reduced pressure atmosphere, when the system is returned to the atmospheric pressure atmosphere, the volume of the void 110 decreases by the pressure difference between the pressure (reduced pressure) in the void 110 and the pressure (atmospheric pressure) exerted to the adhesive sheet 100, and the shrunken void 110 will disappear e.g. as absorbed by the adhesive sheet.

However, in a case where a display panel 50 and a protective plate 10 are bonded via an adhesive sheet 100, as shown in FIG. 11, a void 120 which is open to the exterior may be formed at the periphery of the adhesive sheet 100, in many cases. When one having the display panel 50 and the protective plate 10 bonded via the adhesive sheet 100 under the reduced pressure atmosphere, is returned to the atmospheric pressure atmosphere, the pressure in the void 120 which is open to the exterior will also be returned to the atmospheric pressure, whereby the volume of the void 120 will not decrease, and the void 120 not-shrinked by a pressure difference may remain without being completely absorbed by the adhesive sheet.

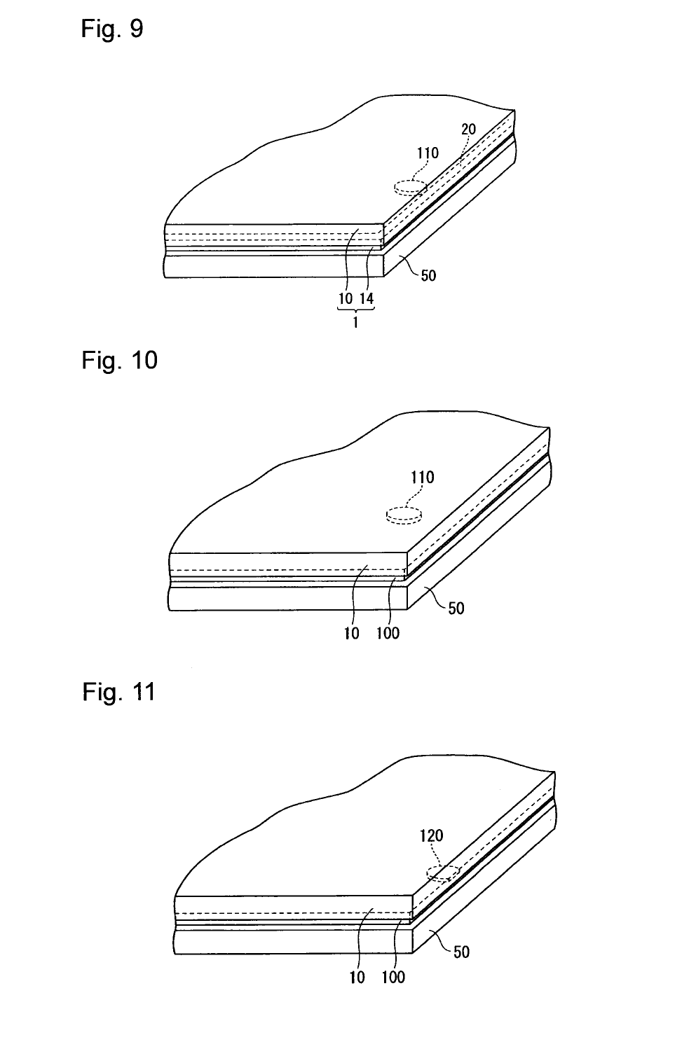

On the other hand, like in the present invention, in the adhesive layer 14, the thickness B of the seal portion 20 is made to be thicker than the thickness A of the layer portion 18, or at least at a part of a region where the seal portion 20 is adjacent to the layer portion 18, the thickness B of the seal portion 20 is made to be thicker than the thickness A of the layer portion, as shown in FIG. 9, even if a void 110 remains at the interface between the display panel 50 and the adhesive layer 14 at the periphery of the adhesive layer 14 at the time of bonding the display panel 50 and the transparent plate 1 having the adhesive layer, such a void 110 is shielded by the seal portion 20, and thus, the void 110 becomes an independent void 110 without becoming open to the exterior. Accordingly, after bonding the display panel 50 and the transparent plate 1 having the adhesive layer in a reduced pressure atmosphere, when the system is returned to the atmospheric pressure atmosphere, the volume of the void 110 will decrease by the pressure difference between the pressure (reduced pressure) in the void 110 and the pressure (atmospheric pressure) exposed to the adhesive layer 14, and the shrunken void 110 will disappear e.g. as absorbed by the adhesive sheet.

In the adhesive layer 14, in a case where the thickness B of the seal portion 20 is made to be thicker than the thickness A of the layer portion 18, the thickness B of the seal portion 20 is made to be thicker preferably by at least 0.005 mm, more preferably by at least 0.01 mm, than the thickness of the layer portion 18.

With a view to preventing formation of voids due to a difference in level between the seal portion 20 and the layer portion 18, the thickness B of the seal portion 20 is made to be thicker preferably by at most 0.05 mm, more preferably by at most 0.03 mm, than the thickness A of the layer portion 18.

In a case where at least at a part of a region where the seal portion 20 is adjacent to the layer portion 18 in the adhesive layer 14, the thickness B of the seal portion 20 is thicker than the thickness A of the layer portion, it is preferred that at a region where the seal portion 20 is adjacent to the layer portion 18, the thickness A of the thinnest part of the layer portion 18 is at least ½ and at most 99/100 of the thickness B of the seal portion. When the thickness A of the thinnest part of the layer portion 18 is at most 99/100 of the thickness B of the seal portion, the void 110 will not be open to the exterior and will be an independent void 110, such being desirable, and when the thickness A of the thinnest part of the layer portion 18 is at least ½ of the thickness B of the seal portion, the void 110 will not be open to the exterior and will sufficiently become an independent void 110.

The difference between the thickness A of the layer portion 18 and the thickness B of the seal portion 20 is obtained by using a laser displacement meter (LK-G80, manufactured by Keyence) by measuring the total thickness of the transparent plate 1 having an adhesive layer, and the layer portion 18 or the seal portion 20 formed thereon to determine the difference. Further, the thickness A of the layer portion 18 is the thickness of the periphery of the layer portion 18 adjacent to the seal portion 20. Usually, a flat plate is used as the transparent plate 1 having an adhesive layer, but in a case where a plate having such a surface shape that a part where the layer portion 18 is to be formed and a part where the seal portion 20 is to be formed are stepped, irrespective of the thickness A of the layer portion 18 or the thickness B of the seal portion, the stepped shape of the surface of the adhesive layer 14 having the protective film 16 removed, may be the same difference in level as the above-mentioned difference between the thickness A of the layer portion 18 and the thickness B of the seal portion 20. Further, the thickness A of the layer portion 18 or the thickness B of the seal portion 20 is preferably a uniform thickness over the entire transparent plate except for at least the part of a region where the seal portion is adjacent to the layer portion.

Further, depending upon the surface shape of the layer portion 18 or the seal portion 20, the above-mentioned measurement of the thickness by means of a laser displacement meter may be difficult, and in such a case, the thickness A of the layer portion 18 and the thickness B of the seal portion 20 may be measured by means of e.g. a surface roughness profilometer (SURFCOM 1440D-12, manufactured by Tokyo Seimitsu Co., Ltd.).

### (Layer Portion)

The layer portion 18 is a layer made of a transparent resin formed by curing the after-described liquid layer portion-forming curable resin composition (hereinafter referred to as the first composition).

The shearing modulus of the layer portion 18 at 25° C. is preferably from 10³ to 10⁷ Pa, more preferably from 10⁴ to 10⁶ Pa. Further, in order to let voids disappear in a short time at the time of bonding, it is particularly preferably from 10⁴ to 10⁵ Pa. When the shearing modulus is at least 10³ Pa, the shape of the layer portion 18 can be maintained. Further, even in a case where the thickness of the layer portion 18 is relatively thick, the thickness of the entire layer portion 18 can be uniformly maintained, and at the time of bonding the transparent plate 1 having an adhesive layer and the display panel, voids will be less likely to be formed at the interface of the display panel and the adhesive layer 14. Further, when the shearing modulus is at least 10⁴ Pa, deformation of the layer portion can easily be prevented at the time of removing the after-described protective film. When the shearing modulus is at most 10⁷ Pa, the layer portion 18 can exhibit good adhesion when bonded to the display panel. Further, as the molecular mobility of the resin material constituting the layer portion 18 is relatively high, the time when the display panel and the transparent plate 1 having an adhesive layer are bonded under a reduced pressure atmosphere and then returned to the atmospheric pressure atmosphere, the volume of a void 110 tends to easily decrease due to the pressure difference between the pressure (reduced pressure) in the void and the pressure (atmospheric pressure) exposed to the layer portion 18, and a gas in the void having the volume reduced is likely to be dissolved and absorbed in the layer portion 18.

The shearing modulus of the layer portion 18 at 25° C. was measured by means of a rheometer (Modular Rheometer Physica MCR-301, manufactured by Anton paar) in such a manner that the space between a measuring spindle and a light transmitting platen was adjusted to be the same as the thickness A of the layer portion 18, and an uncured first composition was placed in the space, and the shearing modulus during the curing process was measured while applying a heat or light required for curing to the uncured first composition, whereby a value measured under a predetermined curing condition was taken as the shearing modulus of the layer portion 18.

The thickness of the layer portion 18 is preferably from 0.03 to 2 mm, more preferably from 0.1 to 0.8 mm. When the thickness of the layer portion 18 is at least 0.03 mm, the layer portion 18 effectively damps an impact, etc. by an external force from the protective plate 10 side, whereby the display panel can be protected. Further, in the process for producing a display device of the present invention, even if foreign contaminants not exceeding the thickness of the layer portion 18 is included between the display panel and the transparent plate 1 having an adhesive layer, the thickness of the layer portion 18 will not be substantially changed, and an influence to the light transmitting performance will be less. When the thickness of the layer portion 18 is at most 2 mm, voids are less likely to remain in the layer portion 18, and the entire thickness of the display device will not be unnecessarily thick.

As a method for adjusting the thickness of the layer portion 18, a method may be mentioned wherein the thickness of the sealing portion 20 is adjusted, and at the same time, the amount of the liquid first composition to be supplied to the surface of the protective plate 10, is adjusted.

### (Seal Portion)

The seal portion 20 is a portion made of a transparent resin formed by applying and curing the after-described liquid seal portion-forming curable resin composition (hereinafter referred to as the second composition). As a region outside of the image display region of a display panel is relatively narrow, the width of the seal portion 20 is preferably made narrow. The width of the seal portion 20 is preferably from 0.5 to 2 mm, more preferably from 0.8 to 1.6 mm. Further, the thickness of the seal portion 20 is substantially equal to an average thickness of the layer portion excluding the region where the seal portion and the layer portion are adjacent to each other, or as mentioned above, is thicker by preferably from 0.005 to 0.05 mm, more preferably from 0.01 to 0.03 mm, than the thickness of the layer portion.

The shearing modulus of the seal portion 20 at 25° C. is preferably larger than the shearing modulus of the layer portion 18 at 25° C. When the shearing modulus of the seal portion 20 is larger than the shearing modulus of the layer portion 18, as shown in FIG. 9, at the time of bonding the display panel 50 and the transparent plate 1 having an adhesive layer, even if a void 110 remains at the interface between the display panel 50 and the adhesive layer 14 at the periphery of the adhesive layer 14, the void 110 is less likely to be open to the exterior and is likely to be an independent void 110. Accordingly, when the display panel 50 and the transparent plate 1 having an adhesive layer are bonded under a reduced pressure atmosphere and then returned to the atmospheric pressure atmosphere, the volume of the void 110 will decrease by the pressure difference between the pressure (reduced pressure) in the void 110 and the pressure (atmospheric pressure) exerted to the adhesive layer 14, and the void 110 tends to readily disappear.

Further, by adjusting the shearing modulus of the seal portion 20 to be larger than the shearing modulus of the layer portion 18, it becomes easy to produce a transparent plate 1 having an adhesive layer wherein, as shown in FIG. 2B, at least at a part of a region where the seal portion 20 is adjacent to the layer portion 18, the thickness B of the seal portion is thicker than the thickness A of the layer portion.

### (Support Plate)

A support plate 36 shown in FIG. 7 to be used in the process of the present invention which will be described hereinafter, is a transparent plate such as a glass plate or a resin plate. In a case where a support plate 36 having a relatively large area is to be used, if the support plate 36 has warpage, deflection or the like, an adverse effect is likely to be brought about to the surface condition of the adhesive layer 14. Therefore, it is preferred to use a glass plate having high rigidity. Further, in a case where a glass plate is used as the support plate 36, the thickness of the glass plate is preferably from 0.5 to 10 mm. If the thickness is thinner than 0.5 mm, warpage or deflection is likely to occur, and if it is thicker than 10 mm, the mass of the support plate 36 becomes unnecessarily large, and the support plate 36 tends to be displaced at the time of moving a laminated member before curing the adhesive layer 14. The thickness of the glass plate is particularly preferably from 1.0 to 5.0 mm.

### (Protective Film)

A protective film 16 is required not to firmly bond to the adhesive layer 14 and to be able to be bonded to the support plate 36 in the process of the present invention which will be described hereinafter. Accordingly, the protective film 16 is preferably a self-adhesive protective film such that one side of a relatively low adhesive substrate film made of e.g. polyethylene, polypropylene or fluororesin, is made to be an adhesive surface. The adhesive force of the adhesive surface of the protective film 16 is preferably from 0.01 to 0.1 N, more preferably from 0.02 to 0.06N, to an acrylic plate by a test specimen having a width of 50 mm in a 180° peeling test at a peeling speed of 300 mm/min. When the adhesive force is at least 0.01 N, adhesion to the support plate 36 is possible, and when it is at most 0.1N, it is easy to peel the protective film 16 from the support plate 36. A preferred thickness of the protective film 16 varies depending upon the resin to be used. In a case where a relatively flexible film such as polyethylene or polypropylene is used, the thickness is preferably from 0.04 to 0.2 mm, further preferably from 0.06 to 0.1 mm. When the thickness is at least 0.04 mm, it is possible to prevent deformation of the protective film 16 at the time of peeling the protective film 16 from the adhesive layer 14, and when it is at most 0.2 mm, the protective film 16 is likely to be easily deflected at the time of peeling, and peeling can easily be carried out. Further, a back layer may be provided on the rear surface on the side opposite to the adhesive surface of the protective film 16 thereby to further facilitate the peeling from the adhesive layer 14.

The adhesion of the protective film 16 to the support plate 36 is carried out by bonding the protective film 16 supplied as wound in the form of a roll, to the support plate 36 by means of e.g. a rubber roll. At that time, in order to prevent formation of voids between the support plate 36 and the adhesive surface of the protective film 16, the rubber roll is pressed against the support plate 36, or bonding is carried out in a reduced pressure atmosphere. In order to facilitate gripping of the end of the protective film 16 at the time of peeling from the adhesive layer 14, it is preferred to use a protective film 16 slightly larger than the support plate 36.

### (Advantageous Effects)

In the transparent plate having an adhesive layer of the present invention as described in the foregoing, an adhesive layer is preliminarily formed on at least one surface of the transparent plate, whereby a step of bonding to another plate (such as a display panel) may be required only once, and bonding to another plate (such as a display panel) is simple.

Further, it is one obtained by the process for producing a transparent plate having an adhesive layer of the present invention which will be described hereinafter, whereby it is possible to sufficiently prevent formation of voids at the interface between the transparent plate and the adhesive layer.

Further, the adhesive layer is formed preliminarily in conformity with the size of the transparent plate, whereby as is different from a conventional adhesive sheet, it is not required to cut the adhesive layer in conformity with the size of the transparent plate or another plate. Especially, in the case of an adhesive layer having a small shearing modulus whereby it is easy to let voids disappear at the time of bonding, it is possible to avoid deformation of the cut surface of the adhesive layer at the time of cutting thereby to avoid remaining of voids at the time of bonding in the vicinity of the cutting surface.

Further, the adhesive layer comprises a layer portion spreading over the surface of the transparent plate and a seal portion enclosing the periphery of the layer portion, wherein the thickness of the seal portion is made thicker than the thickness of the layer portion, or at least at a part of a region where the seal portion is adjacent to the layer portion, the thickness of the seal portion is made thicker than the thickness of the layer portion, whereby at the time of bonding the transparent plate and a display panel, a void at the periphery of the adhesive layer is shielded by the seal portion, so that the void is prevented from being open to the exterior and is likely to be an independent void. Accordingly, when the display panel and the transparent plate having an adhesive layer are bonded under a reduced pressure atmosphere and then returned to the atmospheric pressure atmosphere, the volume of a void will decrease by the pressure difference between the pressure (reduced pressure) in the void and the pressure (atmospheric pressure) exerted to the adhesive layer, and the shrunken void will disappear e.g. as absorbed in the adhesive layer. Therefore, a void is less likely to remain at the interface between the adhesive layer and another plate.

Further, when the shearing modulus of the layer portion at 25° C. is from 10³ to 10⁷ Pa, the shape of the layer portion can be maintained, and further, voids are less likely to be formed at the interface between the display panel and the adhesive layer. Further, the layer portion can exhibit a good adhesive property, and when the display panel and the transparent plate having the adhesive layer are bonded under a reduced pressure atmosphere and then returned to the atmospheric pressure atmosphere, voids tend to readily disappear. The layer portion is supported by the transparent plate (such as a glass plate), and even if the shearing modulus is made sufficiently small (from 10³ to 10⁷ Pa), the shape can be sufficiently maintained. Especially when an adhesive layer having a smaller shearing modulus (at most 10⁵ Pa) whereby voids at the time of bonding can be made to disappear in a shorter time, is supported by the transparent plate, the shape can be maintained with a higher precision.

Further, if a strippable protective film is further provided to cover the surface of the adhesive layer, the shape of the adhesive layer can sufficiently be maintained until just before the bonding to the display panel.

The transparent plate having the adhesive layer as described above is suitable as a protective plate for a display device.

### (Other Modes)

The transparent plate 1 having an adhesive layer shown in the drawings is a case where the transparent plate is a protective plate for a display device, but the transparent plate having an adhesive layer of the present invention is not limited to one shown in the drawings and may be any one so long as the specific adhesive layer is formed on at least one surface of the transparent plate.

For example, the transparent plate having an adhesive layer of the present invention may be one wherein the specific adhesive layer is formed on each side of the transparent plate.

Further, it may be one wherein a polarizing means (such as a film-form absorption type polarizer or a wire grid type polarizer) is provided between the transparent plate (protective plate) and the specific adhesive layer.

<Process for producing transparent plate having adhesive layer>

The process for producing a transparent plate having an adhesive layer of the present invention is a process comprising the following steps (a) to (e):

(a) a step of applying a liquid second composition along the periphery of the surface of a transparent plate to form an uncured seal portion,

(b) a step of supplying a liquid first composition to a region enclosed by the seal portion,

(c) a step of laminating a support plate having a protective film bonded thereto, on the first composition, in a reduced pressure atmosphere of at most 1 kPa, so that the protective film is in contact with the first composition, thereby to obtain a laminated member having an uncured layer portion made of the first composition hermetically sealed by the transparent plate, the protective film and the seal portion,

(d) a step of curing the uncured layer portion in such a state that the laminated member is placed in a pressure atmosphere of at least 50 kPa, to form an adhesive layer comprising the layer portion and the seal portion, and

(e) a step of releasing the support plate from the protective film.

The process of the present invention is a process wherein the liquid first composition is sealed in between the transparent plate and the protective film bonded on the support plate in a reduced pressure atmosphere, and the sealed first composition is cured in a high pressure atmosphere such as the atmospheric pressure atmosphere. The sealing of the first composition under a reduced pressure is not a method of injecting a layer portion-forming curable resin in a wide space with a narrow gap between the protective film bonded and the support plate, but a method of supplying the first composition substantially over the entire surface of the transparent plate and then laminating the protective film bonded to the support plate to seal the first composition between the transparent plate and the protective film bonded to the support plate.

An example of a method for producing a transparent laminated member by sealing a liquid curable resin composition under a reduced pressure and curing the curable resin composition under the atmospheric pressure atmosphere is known. For example, a method for producing a transparent laminated member and a curable resin composition to be used for such a method are disclosed in WO2008/81838 and WO2009/16943, and they are incorporated in this specification by reference.

### (Step (a))

Firstly, a liquid second composition is applied along the periphery of the surface of a transparent plate to form a seal portion.

The application is carried out by means of a printing machine, a dispenser or the like.

The seal portion may be in an uncured state or a partially cured i.e. semicured state. Such partial curing of the seal portion is carried out by irradiation with light in a case where the second composition is a photocurable composition. For example, the photocurable resin composition is partially cured by applying ultraviolet light or visible light with a short wavelength from a light source (such as an ultraviolet lamp, a high pressure mercury lamp, UV-LED or the like).

As one of means to make the thickness B of the seal portion thicker than the thickness A of the layer portion, or to make the thickness B of the seal portion thicker than the thickness A of the layer portion at least at a part of a region where the seal portion is adjacent to the layer portion, the second composition and the first composition are designed so that the shrinkage at the time of curing of the second composition becomes smaller than the shrinkage at the time of curing of the after-described first composition. It is considered that in the layer portion formed by curing the first composition, a shrinkage stress corresponding to the shrinkage at the time of curing remains in the thickness direction of the layer portion, and when the support plate is peeled from the protective film in the after-described step (e), the thickness of the layer portion will decrease slightly due to the shrinkage stress in the thickness direction remaining in the layer portion. By using the first composition having a larger shrinkage at the time of the curing than the second composition, it becomes possible to make the thickness of the seal portion slightly thicker after peeling the support plate from the protective film in the after-described step (e).

One of means to make the shrinkage at the time of curing of the second composition smaller than the shrinkage during the curing of the first composition, is to make the number of curable functional groups in the second composition smaller than the number of curable functional groups in the first composition. For this purpose, in the second composition, (i) the content of a curable compound (monomer) having a small molecular weight may be reduced, or (ii) the content of a curable compound (oligomer) having a large molecular weight may be increased.

That is, the viscosity of the second composition may be made higher than the viscosity of the first composition. Specifically, the viscosity in an uncured state of the second composition is preferably at least 10 times, more preferably at least 100 times, further preferably at least 300 times, the viscosity in an uncured state of the first composition. Further, in order to form a seal portion on the transparent plate by applying the second composition, the viscosity in an uncured state of the second composition at 25° C. is preferably at most 3,000 Pa·s.

Further, the seal portion is required to have hardness of such a level that the shape can be maintained, and an interfacial adhesive strength of at least such a level not to let the liquid first composition leak from the interface between the seal portion and the transparent plate, and from the interface between the seal portion and the protective film, in the after-described step (c). Accordingly, for the seal portion, it is preferred to use a second composition having a high viscosity. Further, in order to maintain the space between the transparent plate and the display panel, spacer particles having a predetermined particle size may be incorporated to the second composition.

The following may, for example, be mentioned as one of means to make the thickness B of the seal portion thicker than the thickness A of the layer portion at least at a part of a region where the seal portion is adjacent to the layer portion, without relying on the difference in shrinkage at the time of curing the first composition and the second composition. By making the viscosity of the second composition sufficiently high thereby to make the applied height along the periphery of the transparent plate higher than the thickness of the seal portion after lamination in the after-described step (c), an uncured seal portion is cured in the after-described step (d) in such a state that a stress due to the flow of the second composition at the time of lamination remains. At that time, the residual stress may sometimes be accumulated at the seal portion after the curing, as a compression stress, and then, when the support plate is peeled in the after-described step (e), the compression stress is released, and the thickness of the seal portion after the curing may become slightly thicker than the thickness before peeling of the support plate i.e. at the time of lamination in step (c). By the first composition having a lower viscosity, there will be no substantial residual stress due to the flow at the time of lamination. Even when the support plate is removed after the curing, a change in thickness of the layer portion after the curing is small, whereby it is possible to make the thickness of the seal portion after the curing thicker than the thickness of the layer portion at least at a part of a region where the seal portion is adjacent to the layer portion.

The viscosity of the second composition is preferably from 500 to 3,000 Pa·s, more preferably from 800 to 2,500 Pa·s, further preferably from 1,000 to 2,000 Pa·s. When the viscosity is at least 500 Pa·s, the shape of an uncured seal portion can be maintained for a relatively long time, and the height of the uncured seal portion can be maintained sufficiently. When the viscosity is at most 3,000 Pa·s, an uncured seal portion can be formed by coating.

The viscosity of the second composition is measured by means of an E type viscometer at 25° C.

The second composition may be a photocurable resin composition or a thermosetting resin composition. As the second composition, preferred is a photocurable resin composition comprising a curable compound and a photopolymerization initiator (C) from such a viewpoint that the curing can be carried out at a low temperature, and the curing rate is high.

From such a viewpoint that the viscosity can be easily adjusted to be within the above range, the seal portion-forming photocurable resin composition is preferably one which comprises, as the above-mentioned curable compounds, at least one oligomer (A) having a curable functional group and a number average molecular weight of from 30,000 to 100,000 and at least one monomer (B) having a curable functional group and a molecular weight of from 125 to 600, wherein the proportion of the monomer (B) is from 15 to 50 mass %, based on the total (100 mass %) of the oligomer (A) and the monomer (B).

The number average molecular weight of the oligomer (A) is from 30,000 to 100,000, preferably from 40,000 to 80,000, more preferably from 50,000 to 65,000. When the number average molecular weight of the oligomer (A) is within such a range, the viscosity of the seal portion-forming photocurable resin composition can easily be adjusted to be within the above-mentioned range.

The number average molecular weight of the oligomer (A) is a number average molecular weight calculated as polystyrene, obtained by GPC (Gel Permeation Chromatography) measurement. Here, in GPC measurement, in a case where a peak attributable to an unreacted low molecular component (such as a monomer) appears, the number average molecular weight is obtained by excluding such a peak.

The curable functional group in the oligomer (A) may, for example, be an addition-polymerizable unsaturated group (such as an acryloyloxy group or a methacryloyloxy group), or a combination of an unsaturated group and a thiol group, and a group selected from an acryloyloxy group and a methacryloyloxy group is preferred, in that the curing rate is high, and a seal portion having high transparency can be obtained. Further, a curable functional group in the relatively high molecular weight oligomer (A) tends to have a lower reactivity than a curable functional group in a relatively low molecular weight monomer (B), and accordingly, curing of the monomer (B) is likely to proceed first, whereby the viscosity of the entire second composition is likely to abruptly increase, and the curing reaction is likely to be non-uniform. In order to minimize the difference in reactivity between the curable functional groups in both to obtain a homogeneous seal portion, it is more preferred that the curable functional group of the oligomer (A) is made to be an acryloyloxy group having a relatively high reactivity, and the curable functional group in the monomer (B) is made to be a methacryloyloxy group having a relatively low reactivity.

As the oligomer (A), one having from 1.8 to 4 curable functional groups, on average, per molecule, is preferred from the viewpoint of the curing property of the seal portion-forming photocurable resin composition and the mechanical properties of the seal portion.

The oligomer (A) may, for example, be a urethane oligomer having a urethane bond, a poly(meth)acrylate of a polyoxyalkylene polyol or a poly(meth)acrylate of a polyester polyol, and a urethane oligomer (A1) is preferred in that the mechanical properties of the resin after curing, the adhesion with the transparent plate or the display panel, etc. can widely be adjusted, for example, by the molecular design of the urethane chain.

A urethane oligomer (A1) having a number average molecular weight of from 30,000 to 100,000 becomes to have a high viscosity and is difficult to synthesize by a usual method, and even if synthesized, mixing it with the monomer (B) is difficult. Therefore, in the present invention, it is preferred that the urethane oligomer (A1) is synthesized by the following method, and then, the obtained product is used as it is, as a seal portion-forming photocurable resin composition, or the obtained product is further diluted with the after-described monomer (B) (such as monomer (B1) or monomer (B3)) and used as a seal portion-forming photocurable resin composition.

### Method for the Synthesis of Urethane Oligomer (A1):

A method wherein in the presence of a monomer (B1) not having a group reactive with an isocyanate group, as one type of the after-described monomer (B), as a diluent, a polyol and a polyisocyanate are reacted to obtain a prepolymer having isocyanate groups, and then, a monomer (B2) having a curable functional group and a group reactive with an isocyanate group, is reacted to the isocyanate groups of the prepolymer.

As the polyol and the polyisocyanate, known compounds, for example, polyol (i), diisocyanate (ii), etc. disclosed as raw materials for a urethane oligomer (a) disclosed in e.g. WO2009/016943, may be mentioned, and they are incorporated in this specification by reference.

The monomer (B1) not having a group reactive with an isocyanate group may, for example, be an alkyl (meth)acrylate having a C₈₋₂₂ alkyl group (such as n-dodecyl (meth)acrylate, n-octadecyl (meth)acrylate or n-behenyl (meth)acrylate, or a (meth)acrylate having an alicyclic hydrocarbon group (such as isobornyl (meth)acrylate or adamantly (meth)acrylate).

The monomer (B2) having a curable functional group and a group reactive with an isocyanate group, may for example, be a monomer having a curable functional group and an active hydrogen (such as a hydroxy group or an amino group), and may specifically be a hydroxyalkyl (meth)acrylate having a C₂₋₆ hydroxyalkyl group (such as 2-hydroxymethyl (meth)acrylate, 2-hydroxypropyl (meth)acrylate, 2-hydroxybutyl (meth)acrylate or 4-hydroxybutyl (meth)acrylate). A hydroxyalkyl acrylate having a C₂₋₄ hydroxyalkyl group is preferred.

The molecular weight of the monomer (B) is from 125 to 600, preferably from 140 to 400, more preferably from 150 to 350. When the molecular weight of the monomer (B) is at least 125, volatilization of the monomer (B) in the after-described reduced pressure atmosphere is prevented. When the molecular weight of the monomer (B) is at most 600, it is possible to increase the solubility of the monomer (B) to the oligomer (A) having a high molecular weight, and it is possible to suitably carry out the viscosity adjustment as a seal portion-forming photocurable resin composition.

The curable functional group in the monomer (B) may, for example, be an addition-polymerizable unsaturated group (such as an acryloyloxy group or a methacryloyloxy group), or a combination of an unsaturated group and a thiol group, and a group selected from an acryloyloxy group and a methacryloyoxy group, is preferred in that the curing rate is high, and a seal portion having high transparency can be obtained. Further, the curable functional group in a monomer (B) having a relatively low molecular weight tends to have a high reactivity than the curable functional group in an oligomer (A) having a relatively high molecular weight, whereby curing of the monomer (B) is likely to proceed first, and the viscosity of the second composition is likely to abruptly increase, and the curing reaction tends to be non-uniform. In order to obtain a homogeneous seal portion, it is more preferred that the curable functional group of the monomer (B) is made to be a methacryloyloxy group having a relatively low reactivity, and the curable functional group of the oligomer (A) is made to be an acryloyloxy group having a relatively high reactivity.

As the monomer (B), one having from 1 to 3 curable functional groups per molecule is preferred from the viewpoint of the curing property of the seal portion-forming photocurable composition and the mechanical properties of the seal portion.

The seal portion-forming photocurable resin composition may contain, as the monomer (B), a monomer (B1) as used as a diluent in the above-described method for the synthesis of a urethane oligomer (A1). Further, as the monomer (B), it may contain an unreacted monomer (B2) as used in the above-described method for the synthesis of a urethane oligomer (A1).

The monomer (B) preferably contains a monomer (B3) having a hydroxy group from the viewpoint of the adhesion between the seal portion and the transparent plate or the display panel, or the solubility of the after-described various additives.

The monomer (B3) having a hydroxy group preferably has 1 or 2 hydroxy groups and may, for example, be preferably a hydroxy methacrylate having a C₃₋₈ hydroxyalkyl group (such as 2-hydroxypropyl methacrylate, 2-hydroxybutyl methacrylate, 4-hydroxybutyl methacrylate or 6-hydroxyhexyl methacrylate), and 2-hydroxybutyl methacrylate is particularly preferred.

The proportion of the monomer (B) is from 15 to 50 mass %, preferably from 20 to 45 mass %, more preferably from 25 to 40 mass %, based on the total (100 mass %) of the oligomer (A) and the monomer (B). When the proportion of the monomer (B) is at least 15 mass %, the curing property of the seal portion-forming photocurable resin composition and the adhesion between the seal portion and the transparent plate or the display panel will be good. When the proportion of the monomer (B) is at most 50 mass %, it will be easy to adjust the viscosity of the seal portion-forming photocurable resin composition to be at least 500 Pa·s.

The photopolymerization initiator (C) may, for example, be a photopolymerization initiator of acetophenone type, ketal type, benzoin or benzoin ether type, phosphine oxide type, benzophenone type, thioxanthone type or quinone type. By using two or more photopolymerization initiators (C) having different absorption wavelength region, in combination, it is possible to further increase the curing rate or to increase the surface hardness in the seal portion.

The amount of the photopolymerization initiator (C) is preferably from 0.01 to 10 parts by mass, more preferably from 0.1 to 2.5 parts by mass, per 100 parts by mass of the total of the oligomer (A) and the monomer (B).

The seal portion-forming photocurable resin composition may contain, as the case requires, other additives such as a polymerization inhibitor, a photocuring accelerator, a chain transfer agent, a light stabilizer (such as an ultraviolet absorber or a radical trapping agent), an antioxidant, a flame retardant, an adhesion-improving agent (such as a silane coupling agent), a pigment, a dye, etc., and it preferably contains a polymerization inhibitor, a light stabilizer, etc. Particularly when a polymerization inhibitor is contained in an amount smaller than the polymerization initiator, the stability of the seal portion-forming photocurable resin composition can be improved, and the molecular weight of the layer portion after curing can also be adjusted.

The polymerization inhibitor may be a polymerization inhibitor of a hydroquinone type (such as a 2,5-di-t-butylhydroquinone), a catechol type (such as a p-t-butylcatechol), an anthraquinone type, a phenothiazine type, a hydroxytoluene type or the like.

The light stabilizer may, for example, be an ultraviolet absorber (such as a benzotriazole type, a benzophenone type or a salicylate type) or a radical trapping agent (such as a hindered amine type).

The antioxidant may be a compound of phosphorus type or sulfur type.

The total amount of such other additives is preferably at most 10 parts by mass, more preferably at most 5 parts by mass, per 100 parts by mass of the total of the oligomer (A) and the monomer (B).

### (Step (b))

After the step (a), a liquid first composition is supplied to a region enclosed by the seal portion.

The amount of the first composition to be supplied is preliminarily set to be such an amount that the space formed by the seal portion, the transparent plate and the protective film is filled with the first composition, and the space between the transparent plate and the protective film is made to be a predetermined distance (i.e. the layer portion is made to have a predetermined thickness). At that time, it is advisable to take into account the volume reduction due to shrinkage by curing of the first composition. Accordingly, the amount is preferably such an amount that the thickness of the first composition becomes to be slightly thicker than the predetermined thickness of the layer portion.

The supply method may, for example, be a method wherein the transparent plate is placed horizontally, and the composition is supplied in a dot shape, in a line shape or a planar shape by a supplying means such as a dispenser, a die coater or the like.

The viscosity of the first composition is preferably from 0.05 to 50 Pa·s, more preferably from 1 to 20 Pa·s. When the viscosity is at least 0.05 Pa·s, the proportion of the after-described monomer (B′) can be reduced, and deterioration of the physical properties of the layer portion can be prevented. Further, the low boiling point component becomes less, whereby volatilization in the after-described reduced pressure atmosphere can be suppressed, such being desirable. When the viscosity is at most 50 Pa·s, voids are less likely to remain in the layer portion.

The viscosity of the first composition is measured by means of an E model viscometer at 25° C.

The first composition may be a photocurable resin composition or a thermosetting resin composition. As the first composition, a photocurable resin composition comprising a curable compound and a photopolymerization initiator (C′), is preferred in that it can be cured at a low temperature, and the curing speed is high.

From such a viewpoint that the viscosity can be easily adjusted to be within the above-mentioned range, the layer portion-forming photocurable composition is preferably one which comprises, as the curable compounds, at least one oligomer (A′) having a curable functional group and a number average molecular weight of from 1,000 to 100,000 and at least one monomer (B′) having a curable functional group and a molecular weight of from 125 to 600, wherein the proportion of the monomer (B′) is preferably from 40 to 80 mass %, more preferably from 50 to 70 mass %, based on the total (100 mass %) of the oligomer (A′) and the monomer (B′).

The number average molecular weight of the oligomer (A′) is from 1,000 to 100,000, preferably from 10,000 to 70,000. When the number average molecular weight of the oligomer (A′) is within such a range, the viscosity of the layer portion-forming photocurable resin composition can easily be adjusted to be within the above range.

The number average molecular weight of the oligomer (A′) is a number average molecular weight as calculated as polystryrene obtained by GPC measurement. Here, in GPC measurement, in a case where a peak attributable to an unreacted low molecular weight component (such as a monomer) appears, the number average molecular weight is obtained by excluding such a peak.

The curable functional group in the oligomer (A′) may, for example, be an addition-polymerizable unsaturated group (such as an acryloyloxy group or a methacryloyloxy group), or a combination of an unsaturated group and a thiol group, and a group selected from an acryloyloxy group and a methacryloyloxy group is preferred in that the curing speed is high, and a layer portion having a high transparency can be obtained. Further, a curable functional group in an oligomer (A′) having a relatively high molecular weight tends to have a lower reactivity than a curable functional group in a monomer (B′) having a relatively low molecular weight, whereby curing of the monomer (B′) is likely to proceed first, and the viscosity of the entire composition is likely to abruptly increase, so that the curing reaction is likely to be non-uniform. In order to obtain a homogeneous layer portion, it is more preferred that the curable functional group of the oligomer (A′) is made to be an acryloyloxy group having a relatively high reactivity, and the curable functional group of the monomer (B′) is made to be a methacryloyloxy group having a relatively low reactivity.

As the oligomer (A′), one having from 1.8 to 4 curable functional groups, on average, per molecule, is preferred from the viewpoint of the curing property of the layer portion-forming photocurable resin composition and the mechanical properties of the layer portion.

The oligomer (A′) may, for example, be a urethane oligomer having a urethane bond, a poly(meth)acrylate of a polyoxyalkylene polyol or a poly(meth)acrylate of a polyester polyol, and a urethane oligomer is preferred in that the mechanical properties of the resin after curing, the adhesion to the transparent plate or the display panel, etc. can be widely adjusted e.g. by molecular design of the urethane chain.

The proportion of the oligomer (A′) is preferably from 20 to 60 mass %, more preferably from 30 to 50 mass %, based on the total (100 mass %) of the oligomer (A′) and the monomer (B′). When the proportion of the oligomer (A′) is at least 20 mass %, the heat resistance of the layer portion will be good. When the proportion of the oligomer (A′) is at most 60 mass %, the curing property of the layer portion-forming photocurable resin composition and the adhesion between the layer portion and the transparent plate or the display panel will be good.

The molecular weight of the monomer (B′) is from 125 to 600, preferably from 140 to 400. When the molecular weight of the monomer (B′) is at least 125, vaporization of the monomer under the after-described reduced pressure atmosphere can be suppressed. When the molecular weight of the monomer (B′) is at most 600, the adhesion between the layer portion and the transparent plate or the display panel will be good.

The curable functional group in the monomer (B′) may, for example, be an addition-polymerizable unsaturated group (such as an acryloyloxy group or a methacryloyloxy group), or a combination of an unsaturated group and a thiol, and a group selected from an acryloyloxy group and a methacryloyloxy group is preferred in that the curing speed is high, and a layer portion having a high transparency can be obtained. Further, a curable functional group in a monomer (B′) having a relatively low molecular weight tends to have a higher reactivity than a curable functional group in an oligomer (A′) having a relatively high molecular weight, whereby curing of the monomer (B′) is likely to proceed first, and the viscosity of the entire composition is likely to abruptly increase, so that the curing reaction is likely to be non-uniform. In order to obtain a homogeneous layer portion, it is more preferred that the curable functional group in the monomer (B′) is made to be a methacryloyoxy group having a relatively low reactivity, and the curable functional group in the oligomer (A′) is made to be an acryloyl group having a relatively high reactivity.

As the monomer (B′), one having from 1 to 3 curable functional groups per molecule is preferred from the viewpoint of the curing property of the layer portion-forming photocurable resin composition and the mechanical properties of the layer portion.

The monomer (B′) preferably contains a monomer (B3) having a hydroxy group from the viewpoint of the adhesion between the layer portion and the transparent plate or the display panel.

The monomer (B3) having a hydroxy group may be the same one as the monomer (B3) in the seal portion-forming photocurable resin composition, and 2-hydroxybutyl methacrylate is particularly preferred.

The proportion of the monomer (B3) is preferably from 15 to 70 mass %, more preferably from 20 to 50 mass %, based on the total (100 mass %) of the oligomer (A′) and the monomer (B′). When the proportion of the monomer (B3) is at least 15 mass %, the curing property of the layer portion-forming photocurable resin composition and the adhesion between the layer portion and the transparent plate or the display panel will be good.

The monomer (B′) preferably contains the following monomer (B4) from the viewpoint of the mechanical properties of the layer portion.

Monomer (B4): An alkyl methacrylate having a C₈₋₂₂ alkyl group.

The monomer (B4) may, for example, be n-dodecyl methacrylate, n-octadecyl methacrylate or n-behenyl methacrylate, preferably n-dodecyl methacrylate or n-octadecyl methacrylate.

The proportion of the monomer (B4) is preferably from 5 to 50 mass %, more preferably from 15 to 40 mass %, based on the total (100 mass %) of the oligomer (A′) and the monomer (B′). When the proportion of the monomer (B4) is at least 5 mass %, the flexibility of the layer portion will be good.

The photopolymerization initiator (C′) may, for example, be a photopolymerization initiator of acetophenone type, ketal type, benzoin or benzoin ether type, phosphine oxide type, benzophenone type, thioxanthone type or quinone type. By using two or more photopolymerization initiators (C′) different in the absorption wavelength region in combination, it is possible to further increase the curing rate.

The amount of the photopolymerization initiator (C′) is preferably from 0.01 to 10 parts by mass, more preferably from 0.1 to 2.5 parts by mass, per 100 parts by mass of the total of the oligomer (A′) and the monomer (B′).

The layer portion-forming photocurable resin composition preferably contains a chain transfer agent. When it contains a chain transfer agent, the shearing modulus of the layer portion at 25° C. tends to be easily adjusted to be from 10³ to 10⁷ Pa.

The chain transfer agent may, for example, be a compound having a thiol group (such as n-octylmercaptan, n-dodeylmercaptan, 1,4-bis(3-mercaptobutyryloxy)butane or pentaerythritol tetrakis(3-mercaptobutyrate)).

The amount of the chain transfer agent is preferably from 0.1 to 4 parts by mass, more preferably from 0.3 to 2 parts by mass, per 100 parts by mass of the total of the oligomer (A′) and the monomer (B′).

On the other hand, the layer portion-forming photocurable resin composition may not contain a chain transfer agent, in a case where the shearing modulus of the layer portion at 25° C. can be adjusted to be from 10³ to 10⁷ Pa without containing a chain transfer agent, by the type or proportion of the oligomer or monomer, or other additives, contained in the layer portion-forming photocurable resin composition.

The layer portion-forming photocurable resin composition may contain, as the case requires, other additives such as a heat absorber, a polymerization inhibitor, a photocuring accelerator, a photostabilizer (such as an ultraviolet absorber or a radical scavenger), an antioxidant, a flame retardant, an adhesion-improving agent (such as a silane coupling agent), a pigment, a dye, etc., and it preferably contains a polymerization inhibitor, a photostabilizer, etc. Especially when the polymerization inhibitor is contained in an amount smaller than the polymerization initiator, the stability of the layer portion-forming photocurable resin composition can be improved, and the molecular weight of the layer portion after curing can also be adjusted.

The total amount of such other additives is preferably at most 10 parts by mass, more preferably at most 5 parts by mass, per 100 parts by mass of the total of the oligomer (A′) and the monomer (B′).

### (Step (c))

After the step (b), the transparent plate having the first composition supplied, is introduced into a reduced pressure apparatus, and the transparent plate is placed horizontally on a fixed support table in the reduced pressure apparatus so that the surface of the first composition faces upward.

At an upper part in the reduced pressure apparatus, a vertically movable support mechanism is provided, and a support plate (such as a glass plate) is attached to the movable support mechanism. A protective film is bonded to the surface on the lower side of the support plate.

The support plate is placed at a position above the transparent plate and not in contact with the first composition. That is, the first composition on the transparent plate and the protective film on the surface of the support plate are permitted to face without being in contact with each other.

Otherwise, a vertically movable support mechanism may be provided at a lower part in the reduced pressure apparatus, and the transparent plate having the first composition supplied, may be placed on the movable support mechanism. In such a case, the support plate is attached to a fixed support table provided at an upper part in the reduced pressure apparatus, and the transparent plate and the support plate are permitted to face each other.

Otherwise, both the transparent plate and the support plate may be supported by movable support mechanisms provided one above the other in the reduced pressure apparatus.

After positioning the transparent plate and the support plate at predetermined positions, the inside of the reduced pressure apparatus is depressurized to a predetermined reduced pressure atmosphere. If possible, during the depressurizing operation or after depressurized to a predetermined reduced pressure atmosphere, the transparent plate and the support plate may be positioned at the predetermined positions in the reduced pressure apparatus.

After the inside of the reduced pressure apparatus becomes to be a predetermined reduced atmosphere, the support plate supported by the movable support mechanism is moved downward to laminate the support plate having the protective film bonded thereto, on the first composition on the transparent plate so that the protective film is in contact with the first composition.

By such laminating, the first composition is sealed in a space enclosed by the surface of the transparent plate, the surface of the protective film bonded to the support plate and the seal portion.

At the time of such laminating, the first composition is pressed and spread by the own weight of the support plate, the pressing pressure from the movable support mechanism, etc., so that the first composition is filled in the above-mentioned space to form an uncured layer portion. Thereafter, when it is exposed to a high pressure atmosphere in the step (d), an uncured layer portion having little or no voids, will be formed.

The reduced pressure atmosphere at the time of such laminating is at most 1 kPa, preferably from 10 to 300 Pa, more preferably from 15 to 100 Pa. If the pressure of the reduced pressure atmosphere is too low, such a reduced pressure atmosphere may adversely affect the respective components (such as a curable compound, a photopolymerization initiator, a polymerization inhibitor, a chain transfer agent, a light stabilizer, etc.) contained in the first composition. For example, if the pressure of the reduced pressure atmosphere is too low, the respective components are likely to volatilize, or it may take time to provide such a reduced pressure atmosphere.

The period of time from the time when the transparent plate and the support plate are laminated to the release of the reduced pressure atmosphere is not particularly limited, and the reduced pressure atmosphere may be released immediately after sealing of the first composition, or after sealing of the first composition, the reduced pressure state may be maintained for a predetermined time. By maintaining the reduced pressure state for a predetermined time, the first composition tends to flow in the sealed space, and the distance between the transparent plate and the protective film bonded to the support plate becomes uniform, whereby even if the atmosphere pressure is increased, the sealed state may easily be maintained. The period of time for maintaining the reduced pressure state may be a long time of at least a few hours, but from the viewpoint of the production efficiency, it is preferably within 1 hour, more preferably within 10 minutes.

In the process of the present invention, in a case where the seal portion is formed by applying a second composition having a high viscosity, the thickness of the first composition in the laminated member obtained in the step (c) can be made to be relatively thick at a level of from 0.03 to 2 mm.

### (Step (d))

After releasing the reduced pressure atmosphere in the step (c), the laminated member is placed in a pressure atmosphere where the pressure of the atmosphere is at least 50 kPa.

When the laminated member is placed in a pressure atmosphere of at least 50 kPa, the transparent plate and the support plate are pressed by the increased pressure in a direction to closely adhere to each other, whereby if voids are present in the sealed space in the laminated member, the uncured layer portion will flow into the voids, and the entire sealed space will be uniformly filled by the uncured layer portion.

The pressure atmosphere is usually from 80 kPa to 120 kPa. The pressure atmosphere may be the atmospheric pressure atmosphere or may be a pressure higher than the atmospheric pressure atmosphere. The atmospheric pressure atmosphere is most preferred from such a viewpoint that the operation of e.g. curing the uncured layer portion can be carried out without requiring any special installation.

The period of time (hereinafter referred to as the high pressure retention time) from the time when the laminated member is placed in a pressure atmosphere of at least 50 kPa to the initiation of the curing of the uncured layer portion is not particularly limited. In a case where a process of taking out the laminated member from the reduced pressure apparatus and transferring it to a curing apparatus, and then initiating the curing, is carried out in an atmospheric pressure atmosphere, the time required for such a process is the high pressure retention time. Accordingly, in a case where at the time when the laminated member is placed in the atmospheric pressure atmosphere, voids are already not present in the sealed space of the laminated member, or voids have disappeared during the process, the uncured layer portion can be immediately cured. In a case where it takes time until voids disappear, the laminated member is held in the atmosphere under a pressure of at least 50 kPa until the voids disappear. Further, usually, there will be no trouble even if the high pressure retention time becomes long, and therefore, the high pressure retention time may be prolonged, because of the other necessity of the process. The high pressure retention time may be as long as more than 1 day, but from the viewpoint of the production efficiency, it is preferably within 6 hours, more preferably within 1 hour, and from the viewpoint of high production efficiency, it is particularly preferably within 10 minutes.

Then, the uncured layer portion and the uncured or semi-cured seal portion are cured, whereby an adhesive layer comprising the layer portion and the seal portion will be formed. At that time, the uncured or semi-cured seal portion may be cured at the same time as the curing of the uncured layer portion, or may preliminarily be cured before the curing of the uncured layer portion.

The uncured layer portion and the uncured or semicured seal portion are cured by irradiation with light, when they are made of photocurable compositions. For example, by applying ultraviolet light or visible light with a short wavelength from a light source (such as an ultraviolet lamp, a high pressure mercury lamp or UV-LED), the photocurable resin compositions are cured.

As such light, ultraviolet light or visible light with a wavelength of at most 450 nm is preferred.

In a case where a light shielding printed part is formed along the periphery of the transparent plate, or an antireflection layer is formed on the transparent plate, and the antireflection layer or a transparent resin film forming such an antireflection layer, or an adhesive layer formed between such an antireflection film and the transparent plate, does not transmit ultraviolet light, light is applied from the support plate side.

In a case where the uncured layer portion is made of a photocurable composition and if it is sufficiently photocured, a proper shearing modulus will not be obtained, irradiation with light may be interrupted halfway in curing, and a layer portion is formed and bonded to another plate (a display panel), whereupon the layer portion may be irradiated with light again or heated, to promote curing of the layer portion. In a case where the curing is promoted by heating, a very small amount of a thermal polymerization initiator may be incorporated to the photocurable composition. Here, even in a case where no thermal polymerization initiator is incorporated, it is preferred to heat and maintain the layer portion after incomplete photocuring, whereby the cured state of the layer portion can be stabilized.

The process of the present invention is carried out usually at such a low temperature that the film is durable, such being advantageous with a view to protection of the protective film.

### (Step (e))

By releasing the support plate from the protective film, it is possible to obtain the transparent plate having the adhesive layer, wherein the adhesive layer having a sufficient adhesive strength is preliminarily formed on the transparent plate, and formation of voids at the interface between the transparent plate and the adhesive layer is sufficiently prevented.

### Specific Embodiment

Now, the process for producing a transparent plate 1 having an adhesive layer in FIG. 1 will be specifically described with reference to the drawings.

### (Step (a))

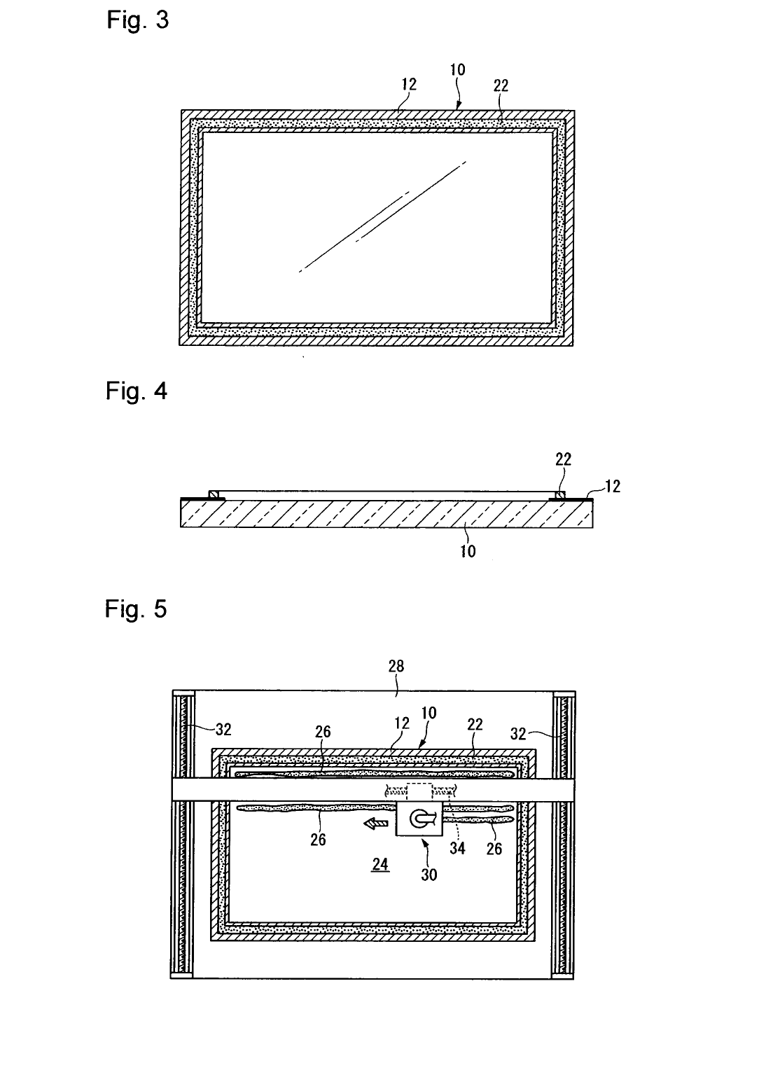

As shown in FIGS. 3 and 4, a seal portion-forming photocurable resin composition is applied along a light shielding printed part 12 at the periphery of a protective plate 10 (transparent plate) by means of e.g. a dispenser (not shown) to form an uncured seal portion 22.

### (Step (b))

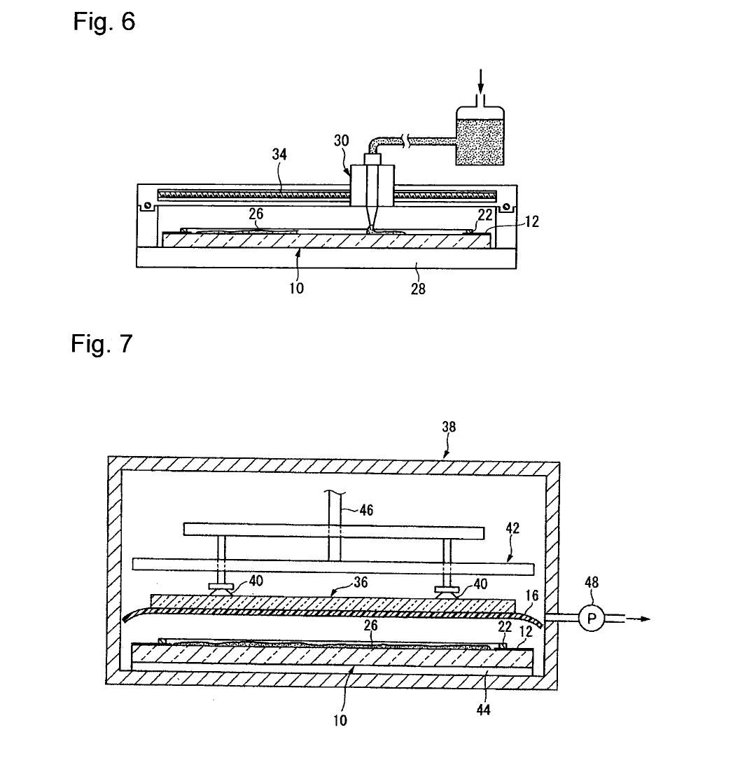

Then, as shown in FIGS. 5 and 6, a layer portion-forming photocurable resin composition 26 is supplied to a rectangular region 24 enclosed by the uncured seal portion 22 of the protective plate 10. The amount of the layer portion-forming photocurable resin composition 26 to be supplied is preliminarily set to be such an amount that the space sealed by the uncured seal portion 22, the protective plate 10 and the protective film 16 (see FIG. 7) will be filled with the layer portion-forming photocurable resin composition 26.

As shown in FIGS. 5 and 6, the supplying of the layer portion-forming photocurable resin composition 26 is carried out by placing the protective plate 10 horizontally on a lower platen 28 and supplying the layer portion-forming photocurable resin composition 26 in a line-, strip- or dot-form by a dispenser 30 moving in a horizontal direction.

The dispenser 30 is made to be horizontally movable over the entire range of the region 24 by a known horizontal movement mechanism comprising a pair of feed screws 32 and a feed screw 34 perpendicular to the feed screws 32. Here, instead of the dispenser 30, a die coater may be employed.

### (Step (c))

Then, as shown in FIG. 7, the protective plate 10 and the support plate 36 having a protective film 16 bonded thereto, are introduced into a reduced pressure apparatus 38. At an upper part in the reduced pressure apparatus 38, an upper platen 42 having a plurality of adsorption pads 40 is disposed, and at a lower part, a lower platen 44 is provided. The upper platen 42 is made to be movable in a vertical direction by an air cylinder 46.

The support plate 36 is attached to the adsorption pads 40 with the side having the protective film 16 bonded thereto, to face downward. The protective plate 10 is fixed on the lower platen 44 with the side having the layer portion-forming photocurable resin composition 26 supplied, to face upward.

Then, the air in the reduced pressure apparatus 38 is suctioned by a vacuum pump 48. After the atmosphere pressure in the reduced pressure apparatus 38 reaches a reduced pressure atmosphere of e.g. from 15 to 100 Pa, the support plate 36 is lowered in a state adsorbed and held by the adsorption pads 40 of the upper platen 42, towards the protective plate 10 waiting below, by operating the air cylinder 46. And, the protective plate 10 and the support plate 36 having the protective film 16 bonded thereto, are laminated via the uncured seal portion 22 to form a laminated member wherein the uncured layer portion made of the layer portion-forming photocurable resin composition 26 is sealed by the protective plate 10, the protective film 16 and the uncured seal portion 22, and the laminated member is held in a reduced pressure atmosphere for a predetermined period of time.

Here, the attached position of the protective plate 10 to the lower platen 44, the number of adsorption pads 40, the attached position of the support plate 36 to the upper platen 42, etc. are suitably adjusted depending upon the sizes, shapes, etc. of the protective plate 10 and the support plate 36. At that time, the support plate 36 can be held in the reduced pressure atmosphere stably by using electrostatic chucks as the adsorption pads and adopting the electrostatic chuck holding method as disclosed in WO2010/016588 (which is incorporated herein by reference).

### (Step (d))

Then, the inside of the reduced pressure apparatus 38 is made to be e.g. the atmospheric pressure atmosphere, and then the laminated member is taken out from the reduced pressure apparatus 38. When the laminated member is placed in the atmospheric pressure atmosphere, the surface on the protective plate 10 side and the surface on the support plate 36 side of the laminated member are pressed by the atmospheric pressure atmosphere, and the uncured layer portion in the sealed space is pressed by the protective plate 10 and the support plate 36. By this pressure, the uncured layer portion in the sealed space will flow, and the entire sealed space will be uniformly filled with the uncured layer portion.

Then, from the side of the support plate 36, light (ultraviolet light or visible light with a short wavelength) is applied to the seal portion 22 and the uncured layer portion to cure the uncured layer portion inside of the laminated member thereby to form an adhesive layer comprising the layer portion and the seal portion.

### (Step (e))

Then, the support plate 36 is released from the protective film 16, whereby the transparent plate 1 having the adhesive layer is obtained.

### (Advantageous Effects)

By the above-described process for producing a transparent plate having an adhesive layer of the present invention, a transparent plate having an adhesive layer, which has a relatively large area, can be produced without letting voids to form at the interface between the adhesive layer and the transparent plate or the protective film. Even if voids remain in the uncured layer portion sealed under reduced pressure, in a high pressure atmosphere before curing, the pressure is exerted also to the sealed uncured layer portion, whereby the volume of such voids decreases, and shrunken voids will readily disappear as absorbed in the adhesive layer. For example, the volume of a gas in a void in the uncured layer portion sealed under 100 Pa is considered to become 1/1000 under 100 kPa. The gas in a void may sometimes be dissolved and absorbed in the uncured layer portion, the gas in the shrunken void will be readily dissolved and will disappear in the uncured layer portion.

Further, as compared with a method (injection method) of injecting a liquid curable resin composition in a space narrow and wide between a pair of plates, it is possible to fill the first composition with less formation of voids and in a shorter period of time. Besides, a restriction is less with respect to the viscosity of the first composition, and a first composition having a high viscosity can easily be filled.

Accordingly, it is possible to employ a first composition having a high viscosity, which contains a curable compound having a relatively high molecular weight, whereby the shearing modulus of the layer portion can easily be reduced.

Further, it is possible to form a relatively thick adhesive layer while maintaining the uniformity of the thickness, on the surface of a transparent plate having a large area, whereby the transparent plate having the adhesive layer thereby obtainable, can sufficiently prevent formation of voids even in bonding with another plate (such as a display panel) having a large area, which is likely to be deflected.

Further, the adhesive layer is formed in conformity with the size of the transparent plate, and as is different from a conventional adhesive sheet, it is not required to cut the adhesive layer in conformity with the size of the transparent plate or another plate. Especially in the case of an adhesive layer having a low elastic modulus, there will be no such a worry that its shape is deformed by cutting and voids will remain at the deformed portion at the time of bonding.

### <Display Device>

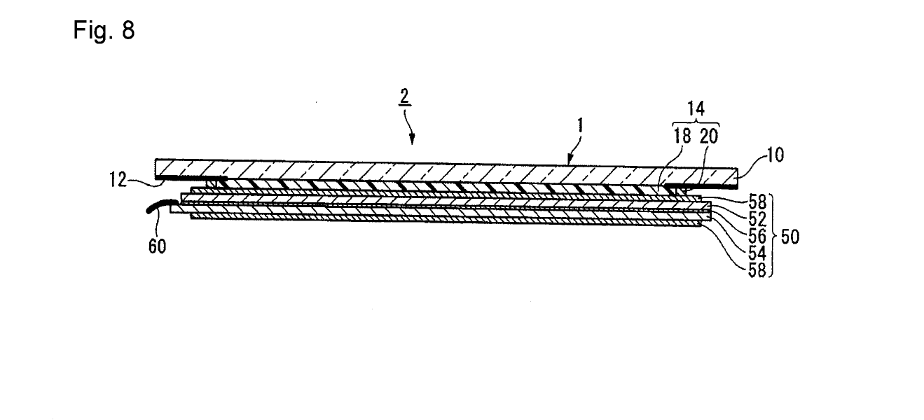

FIG. 8 is a cross-sectional view illustrating an example of the display device of the present invention.

The display device 2 comprises a display panel 50 and a transparent plate 1 having an adhesive layer, which is bonded to the display panel 50 so that the adhesive layer 14 is in contact with the display panel 50.

The display device 2 has a protective plate 10, the display panel 50, a layer portion 18 interposed between the protective plate 10 and the display panel 50, a seal portion 20 enclosing the periphery of the layer portion 18, and a flexible printed circuit board 60 (FPC) connected to the display panel 50 and mounting a driving IC to drive the display panel 50.

### (Display Panel)

The display panel 50 shown in the drawing is an example of a liquid crystal panel having such a construction that a transparent substrate 52 provided with a color filter and a transparent substrate 54 provided with TFT are bonded via a liquid crystal layer 56, and this assembly is sandwiched between a pair of polarizing plates 58. However, the display panel in the present invention is not limited to the one shown in the drawing.

The display panel is one wherein a display material, of which the optical mode is changed by external electrical signals, is sandwiched between a pair of electrodes, of which at least one is transparent electrode, or between a transparent substrate and a substrate having a plurality of electrode pairs formed in the same plane. Depending upon the type of the display material, it may, for example, be a liquid crystal panel, an EL panel, a plasma panel or an electronic ink type panel. Further, the display panel has a structure wherein a pair of plates are bonded together, for which at least one is a transparent plate, and it is disposed so that the transparent plate side is in contact with the layer portion. At that time, in some display panels, an optical film such as a polarizing plate or a retardation film may be provided on the outermost layer side of the transparent plate substrate on the side in contact with the layer portion. In such a case, the layer portion takes a form to bond the protective plate and the optical film on the display panel.

Surface treatment may be applied to the surface of the display panel to be bonded to the layer portion in order to improve the interface bonding strength with the seal portion. Such surface treatment may be applied only along the periphery or over the entire surface of the plate. As the method for surface treatment, a method of treatment with a low temperature processable bonding primer may, for example, be mentioned.

The thickness of the display panel is usually from 0.4 to 4 mm in the case of a liquid crystal panel to be operated by TFT, or usually from 0.2 to 3 mm in the case of an EL panel.

### (Shape)

The shape of the display device is usually rectangular.

The process of the present invention is suitable particularly for the production of a display device having a relatively large area, and therefore, in the case of a television receiver using a liquid crystal panel, the size of the display device is suitably at least 0.5 m×0.4 m, particularly preferably at least 0.7 m×0.4 m. The upper limit of the size of the display device is determined by the size of the display panel in many cases. Further, if the display device is too large, its handling, for example, in its installation tends to be difficult. From such restrictions, the upper limit of the size of the display device is usually about 2.5 m×1.5 m.

The sizes of the protective plate and the display panel may be substantially equal, but from the relation with another housing for accommodating the display device, the protective plate may be slightly larger than the display panel in many cases. On the contrary, depending upon the structure of another housing, the protective plate may be made to be slightly smaller than the display panel.

### (Advantageous Effects)

The above-described display device of the present invention is one wherein a transparent plate having an adhesive layer obtained by the process for producing a transparent plate having an adhesive layer of the present invention, is bonded to a display panel so that the adhesive layer is in contact with the display panel, and accordingly becomes one wherein formation of voids at the interface between the display panel and the adhesive layer and at the interface between the transparent plate and the adhesive layer, is sufficiently prevented.

Further, in the transparent plate having the adhesive layer, the thickness of the seal portion is made thicker than the thickness of the layer portion, or at least at a part of a region where the seal portion is adjacent to the layer portion, the thickness of the seal portion is thicker than the thickness of the layer portion, whereby formation of voids at the interface between the display panel and the adhesive layer will be sufficiently prevented.

Further, when the shearing modulus of the layer portion of the adhesive layer at 25° C. is from 10³ to 10⁷ Pa, a pressure at the time of bonding to the liquid crystal panel will not remain in the adhesive layer and will not present an adverse effect to the liquid crystal alignment in the liquid crystal panel, whereby deterioration of the image quality will be prevented.

Further, by making the elastic modulus of the seal portion of the adhesive layer larger than the elastic modulus of the layer portion, it is possible to effectively prevent deformation of the adhesive layer at the periphery of the adhesive layer where a pressure may be concentrated at the time of bonding when the display panel and the transparent plate having the adhesive layer are bonded. Further, it is possible to prevent remaining of a non-uniform stress in the adhesive layer after bonding thereby to avoid an adverse effect to the liquid crystal alignment at the periphery in the liquid crystal panel and to prevent deterioration of the image quality.

### <Process for Producing Display Device>

The process for producing the display device of the present invention is a process which comprises laminating and bonding the display panel and the transparent plate having an adhesive layer of the present invention so that the adhesive layer is in contact with the display panel, in a reduced pressure atmosphere of at most 1 kPa, after releasing the protective film from the transparent plate having an adhesive layer of the present invention.

In a case where the shearing modulus of the layer portion of the adhesive layer is made sufficiently small, the adhesive layer is cooled at the time of peeling the protective film to increase the shearing modulus of the adhesive layer, whereby the protective film can easily be peeled. Further, deformation of the adhesive layer at the time of peeling the protective film can be prevented, and it is possible to increase the uniformity in thickness of the adhesive layer after the protective film is peeled, and to prevent formation of voids at the time of bonding to a display panel.

The temperature for cooling the adhesive layer varies depending upon the glass transition temperature of the resin to be used for the adhesive layer, but it is preferably at most a temperature higher by about 40° C. than the glass transition temperature when the glass transition temperature is regarded as a temperature showing the maximum value of loss elastic modulus in the measurement of the shearing modulus. The lower limit temperature is not particularly limited, but it is usually at a level of −30° C. is preferred, since depending upon the resin to be used for the protective film, the film is likely to be brittle at a low temperature and is likely to split at the time of peeling.

The reduced pressure atmosphere at the time of bonding is at most 1 kPa, preferably from 10 to 500 Pa, more preferably from 15 to 200 Pa.

The period of time from the time when the display panel and the transparent plate having an adhesive layer are laminated to the time when the releasing of the reduced pressure atmosphere may be a long time of at least a few hours, but from the viewpoint of the production efficiency, it is preferably within 1 hour, more preferably within 10 minutes.

After bonding the display panel and the transparent plate having an adhesive layer, the adhesive layer, of which curing is still incomplete, may be irradiated with light again or heated to promote the curing of the adhesive layer thereby to stabilize the cured state of the adhesive layer.

### (Advantageous Effects)

In the above-described process for producing a display device of the present invention, a transparent plate having an adhesive layer of the present invention, wherein an adhesive layer is preliminarily formed on at least one surface of the transparent plate, is employed, whereby only one step is required for the bonding to a display panel, and the bonding to the display panel is simple.

Further, the display panel and the transparent plate having an adhesive layer, obtained by the process for producing a transparent plate having an adhesive layer of the present invention, are laminated and bonded so that the adhesive layer is in contact with the display panel, in a reduced pressure atmosphere of at most 1 kPa, whereby voids are less likely to remain at the interface between the display panel and the adhesive layer.

Further, a transparent plate having an adhesive layer obtained by the process for producing a transparent plate having an adhesive layer of the present invention, is employed, whereby formation of voids at the interface between the transparent plate and the adhesive layer is sufficiently prevented.

Further, in the transparent plate having an adhesive layer, the thickness of the seal portion is made thicker than the thickness of the layer portion, or at least at a part of a region where the seal portion is adjacent to the layer portion, the thickness of the seal portion is thicker than the thickness of the layer potion, whereby formation of voids at the interface between the display panel and the adhesive layer is sufficiently prevented.

Further, when the shearing modulus of the layer portion of the adhesive layer at 25° C. is from 10³ to 10⁷ Pa, voids are less likely to be formed at the interface between the display panel and the adhesive layer. Further, after the display panel and the transparent plate having the adhesive layer are bonded in a reduced pressure atmosphere, when such an assembly is exposed to the atmospheric pressure atmosphere, voids tend to readily disappear.

Further, the transparent plate having the adhesive layer of the present invention has a construction comprising the seal portion and the layer portion, whereby it is possible to form a relatively thick adhesive layer on the surface of the transparent plate having a large area, while maintaining the uniformity in thickness, and it is possible to sufficiently prevent formation of voids also in bonding between a display panel having a large area, which is likely to be deflected, and the transparent plate having the adhesive layer.

### EXAMPLES

Now, Examples will be described which were carried out to confirm the effectiveness of the present invention. The present invention will be described in further detail with reference to Examples and a Comparative example, but, it should be understood that the present invention is by no means limited to the following Examples.

Examples 1 and 3 are Working Examples of the present invention, and Example 2 is a Comparative Example.

### (Number Average Molecular Weight)

The number average molecular weight of an oligomer was obtained by means of GPC apparatus (HLC-8020, manufactured by TOSOH CORPORATION).

### (Viscosity)

The viscosity of a photocurable resin composition was measured by means of E model viscometer (RE-85U, manufactured by Toki Sangyo Co., Ltd.)

### (Thickness)

The thickness of each of the layer portion and the seal portion of the adhesive layer was measured at 10 positions by means of a laser displacement meter (LK-G80, manufactured by Keyence), and the average value was obtained.

In a case where the measurement by the laser displacement meter was difficult, the thickness of each of the layer portion and the seal portion was measured by means of a surface roughness profilometer (SURFCOM 1400D-12, manufactured by Tokyo Seimitsu Co., Ltd.).

### (Haze Value)

The haze value was obtained by measurement in accordance with ASTMD1003 by using HAZE GARD II manufactured by Toyo Seiki Seisaku-sho, Ltd.

### (Shearing Modulus)

For measuring the shearing modulus of the layer portion of the adhesive layer, using a rheometer (Modular Rheometer Physica MCR-301, manufactured by Anton paar), a space between a measuring spindle and a light-transmitting plate is adjusted to be the same as the thickness of the layer portion, an uncured first composition or second composition is placed in the space, and the shearing modulus during the curing process is measured, while irradiating the uncured first composition or second composition with light necessary for curing, via the light-transmitting plate, and the shearing modulus of the layer portion or seal portion under predetermined curing conditions, was measured.

### Example 1

### (Transparent Plate)

Along the periphery of one surface of a soda lime glass having a length of 794 mm, a width of 479 mm and a thickness of 3 mm, a light shielding printed part was formed in a frame form by ceramic printing containing a black pigment so that the light transmitting part had a length of 698 mm and a width of 392 mm. Then, over the entire surface of the backside of the light shielding printed part, an antireflection film (Realook X4001, manufactured by NOF Corporation) was bonded in such a state that a protective film was provided, to prepare a protective plate A.

### (Support Plate)

On one side of a soda lime glass having a length of 814 mm, a width of 499 mm and a thickness of 3 mm, a protective film (Puretect VLH-9, manufactured by TOHCELLO Co., Ltd.) having a length of 900 mm, a width of 600 mm and a thickness of 0.75 mm was bonded by means of a rubber roll, so that the bonding surface of the protective film was in contact with the glass to obtain a support plate B having the protective film bonded thereto.

### (Display Panel)

A liquid crystal panel was taken out from a commercially available 32-inch liquid crystal television receiver (HDV-32WX2D-V manufactured by PC DEPOT CORPORATION). The liquid crystal panel had a length of 712 mm, a width of 412 mm and a thickness of about 2 mm. On each side of the liquid crystal panel, a polarizing plate was bonded, and six driving FPC were connected to one long side, and a printed circuit board was connected to the ends of FPC. The image display region had a length of 696 mm and a width of 390 mm. Such a liquid crystal panel was designated as display panel A.

### (Photocurable Resin Composition for Forming Seal Portion)

A bifunctional polypropylene glycol having the molecular terminal modified by ethylene oxide (number average molecular weight calculated by hydroxy value: 4,000) and hexamethylene diisocyanate were mixed in a molar ratio of 6:7, then diluted with isobornyl acrylate (IBXA manufactured by OSAKA ORGANIC CHEMICAL INDUSTRY LTD.) and then reacted at 70° C. in the presence of a tin compound catalyst to obtain a prepolymer, to which 2-hydroxyethyl acrylate was added in a molar ratio of substantially 1:2, followed by a reaction at 70° C. thereby to obtain an urethane acrylate oligomer (hereinafter referred to as UC-1) solution diluted with 30 mass % of isobornyl acrylate. The number of curable functional groups in UC-1 was 2, and the number average molecular weight was about 55,000. The viscosity at 60° C. of the UC-1 solution was about 580 Pa·s.

90 Parts by mass of the UC-1 solution and 10 parts by mass of 2-hydroxybutyl methacrylate (LIGHT ESTER HOB manufactured by Kyoeisha Chemical Co., Ltd.) were uniformly mixed to obtain a mixture. 100 Parts by mass of this mixture, 0.9 part by mass of 1-hydroxy-cyclohexyl-phenyl-ketone (photopolymerization initiator, IRGACURE 184, manufactured by Ciba Specialty Chemicals), 0.1 part by mass of bis(2,4,6-trimethylbenzoyl)-phenylphosphine oxide (photopolymerization initiator, IRGACURE 819, manufactured by Ciba Specialty Chemicals) and 0.04 part by mass of 2,5-di-t-butylhydroquinone (polymerization inhibitor, manufactured by Tokyo Kasei) were uniformly mixed to obtain a seal portion-forming photocurable resin composition C.

The seal portion-forming photocurable resin composition C was put in a container, and in an open state, set in a reduced-pressure apparatus. The inside of the reduced-pressure apparatus was depressurized to about 20 Pa and maintained for 10 minutes to carry out defoaming treatment. The viscosity at 25° C. of the seal portion-forming photocurable resin composition C was measured and found to be about 1,400 Pa·s.

### (Layer Portion-Forming Photocurable Resin Composition)

A bifunctional polypropylene glycol having the molecular terminal modified with ethylene oxide (number average molecular weight calculated from the hydroxy value: 4,000) and isophorone diisocyanate were mixed in a molar ratio of 4:5 and reacted at 70° C. in the presence of a tin compound catalyst to obtain a prepolymer, to which 2-hydroxyethyl acrylate was added in a molar ratio of substantially 1:2 and reacted at 70° C. to obtain an urethane acrylate oligomer (hereinafter referred to as UA-1). The number of curable functional groups in UA-1 was 2; the number average molecular weight was about 24,000; and the viscosity at 25° C. was about 830 Pa·s.

40 Parts by mass of UA-1, 20 parts by mass of 2-hydroxybutyl methacrylate (LIGHT ESTER HOB manufactured by Kyoeisha Chemical Co., Ltd.) and 40 parts by mass of n-dodecyl methacrylate were uniformly mixed, and then, to 100 parts by mass of the mixture, 0.3 part by mass of bis(2,4,6-trimethylbenzoyl)-phenylphosphine oxide (photopolymerization initiator, IRGACURE 819, manufactured by Ciba Specialty Chemicals), 0.04 part by mass of 2,5-di-t-butylhydroquinone (polymerization inhibitor, manufactured by Tokyo Kasei), 0.5 part by mass of n-dodecylmercaptan (chain transfer agent, THIOKALCOL 20, manufactured by Kao Corporation) and 0.3 part by mass of an ultraviolet absorber (TINUVIN 109 manufactured by Ciba Specialty Chemicals K.K.) were uniformly dissolved to obtain a layer portion-forming photocurable resin composition D.

The layer portion-forming photocurable resin composition D was put in a container and in an open state, set in a reduced-pressure apparatus. The inside of the reduced-pressure apparatus was depressurized to about 20 Pa and maintained for 10 minutes to carry out defoaming treatment. The viscosity at 25° C. of the layer portion-forming photocurable resin composition D was measured and found to be 1.7 Pa·s.

### (Step (a))

Along the entire periphery at a position of about 5 mm from the inner edge of the light shielding printed part of the protective plate A, the seal portion-forming photocurable resin composition C was applied by a dispenser so that the width was about 1 mm, and the coated thickness was about 0.6 mm, thereby to form an uncured seal portion.

### (Step (b))

To a region inside of the uncured seal portion formed on the protective plate A, the layer portion-forming photocurable resin composition D was supplied at plural positions by means of a dispenser so that the total mass would be 125 g.

During the supply of the layer portion-forming photocurable resin composition D, the shape of the uncured seal portion was maintained.

### (Step (c))

On the lower press platen in a reduced-pressure apparatus wherein a lifting and lowering apparatus comprising a pair of press platens was set, the protective plate A was placed horizontally so that the surface of the resin layer-forming photocurable resin composition D faced upward.

The support plate B having a protective film bonded thereto, was held on the lower surface of an upper press platen of the lifting and lowering apparatus in the reduced-pressure apparatus by means of an electrostatic chuck so that in a vertical direction, the distance from the protective plate A became 30 mm.

The reduced-pressure apparatus was made in a sealed state and depressurized until the pressure in the reduced-pressure apparatus became about 10 Pa. By the lifting and lowering apparatus in the reduced-pressure apparatus, the upper and lower press platens were brought to be closer to each other so that the protective plate A and the support plate B having a protective film bonded thereto, were pressed under a pressure of 2 kPa through the layer portion-forming photocurable resin composition D and held for 1 minute. The electrostatic chuck was deactivated, and from the upper press platen, the support plate was released, and the inside of the reduced-pressure apparatus was returned to the atmospheric pressure atmosphere in about 15 seconds to obtain a laminated member E having an uncured layer portion made of the layer portion-forming photocurable resin composition D sealed by the protective plate A, the protective film and the seal portion.

In the laminated member E, the shape of the seal portion was maintained substantially in the initial state.

### (Step (d))

The seal portion and the uncured layer portion of the laminated member E were uniformly irradiated with ultraviolet light and visible light with a wavelength of at most 450 nm from the support plate side to cure the uncured layer portion thereby to form an adhesive layer. Defects such as voids remaining in the adhesive layer were not observed though a step of removing voids which is required in the production by a conventional injection method, was unnecessary. Further, a defect such as leakage of the layer portion-forming photocurable resin composition from the seal portion was not observed. Further, the thickness of the adhesive layer (the thickness of the seal portion 20 and the thickness of the layer portion) was at the desired level (about 0.4 mm).

### (Step (e))

The support plate was released from the protective film to obtain a transparent plate F having the adhesive layer, to which the protective film was bonded. Such a transparent plate F having the adhesive layer was placed horizontally in a constant temperature tank at 60° C. and heated for 1 hour, and then taken out. No voids were observed at the interface between the protective plate A and the adhesive layer.

The protective film was peed from the transparent plate F having the adhesive layer, and at the region where the seal portion of the adhesive layer was adjacent to the layer portion, the shapes of the seal portion and the layer portion were measured by a laser displacement meter and compared, whereby there was a difference in level of about 20 μm in the vicinity of the boundary between the seal portion and the layer portion, and the seal portion was thicker than the layer portion. The thickness of the layer portion was 0.4 mm.

Further, the shearing modulus of the seal portion and the layer portion of the adhesive layer was measured after curing under the same conditions as the above step (d) and was found to be 7×10⁵ Pa and 5×10⁴ Pa, respectively.

### (Production of Display Panel)

On the lower press platen in a reduced-pressure apparatus wherein a lifting and lowering apparatus comprising a pair of press platens was set, a display panel G was placed horizontally so that the display surface faced upward.

The transparent plate F having an adhesive layer, from which the protective film was peeled, was held on the lower surface of an upper press platen of the lifting and lowering apparatus in the reduced pressure apparatus by means of an electrostatic chuck so that the adhesive layer surface faced downward, and the distance to the display panel G became 30 mm. At that time, the holding position of the transparent plate F having the adhesive layer was adjusted so that the entire display region of the display panel G was disposed in the region of a light transmitting part enclosed by the light shielding printed part of the transparent plate F having the adhesive layer.

The reduced pressure apparatus was made in a sealed state and depressurized until the pressure in the reduced pressure apparatus became about 10 Pa. By the lifting and lowering apparatus in the reduced pressure apparatus, the upper and lower press platens were brought to be closer to each other so that the display panel G and the transparent plate F having the adhesive layer were pressed under a pressure of 2 kPa through the adhesive layer and held for 1 minute. The electrostatic chuck was deactivated, and from the upper platen, the transparent plate F having the adhesive layer was released, and the inside of the reduced pressure apparatus was returned to the atmospheric pressure in about 20 seconds to obtain a display device H.

The display device H was left to stand still for 10 minutes and then observed, whereby many tiny voids were observed at the interface between the display panel G and the adhesive layer. The display device H was left to stand for 10 hours and then, observed again, whereby the voids were found to have all disappeared, and a display device H wherein the display panel G and the transparent plate F having the adhesive layer were bonded through the adhesive layer without any defects, was obtained.

The display device H was returned to the housing of the liquid crystal television receiver from which the display panel G was taken out, and the wiring was re-connected, and the television receiver was switched on, whereby a homogeneous good image was obtained, which was one having a display contrast higher than the initial level. Even if the image display surface was pushed strongly with a finger, no image distortion was observed, and the transparent plate F having the adhesive layer effectively protected the display panel G.

Instead of the display panel G, a soda lime glass having substantially the same shape as the display panel G and having a thickness of 2 mm was bonded to the transparent plate F having the adhesive layer in the same step as for the production of the above display panel, to obtain a laminated member H′. The laminated member H′ was left to stand for 10 hours in the same manner as the display device H, whereupon the haze value of the light transmitting part of the laminated member H′ was measured and found to be at most 1%, and thus, it had good transparency.

### Example 2

A transparent plate I having an adhesive layer was obtained in the same manner as in Example 1 except that for the formation of the adhesive layer, only the uncured layer portion-forming photocurable resin composition D was used without forming the seal portion by the seal portion-forming photocurable resin composition C. In this case, the layer portion slightly flowed and spread towards the periphery at the time of the lamination with the support plate, but no voids were observed at the interface between the protective plate A and the adhesive layer.

The protective film was peeled from the transparent plate I having the adhesive layer, and the thickness of the adhesive layer by the cured layer portion was measured over the entire surface of the adhesive layer, whereby the peripheral part was found to be slightly thin as compared with the center part of the adhesive layer.

In the same manner as in Example 1 except that the transparent plate I having the adhesive layer was used, a display device K was obtained by bonding it with a display panel J taken out from a TV receiver of the same type as the TV receiver from which the display panel G was taken out, in a reduced pressure apparatus.

The display device K was left to stand still for 10 minutes and then observed, whereby many tiny voids were observed at the interface between the display panel J and the adhesive layer. The display device K was left to stand for 10 hours and then, observed again, whereby the voids in the vicinity of the center of the adhesive layer were found to have disappeared, but many voids open to the exterior were found to remain at the peripheral part of the adhesive layer.

The display device K was returned to the housing of the liquid crystal television receiver from which the display panel J was taken out, and the wiring was re-connected, and the television receiver was switched on, whereby the image in the vicinity where voids remained in the adhesive layer, was non-uniform.

### Example 3

A transparent plate L having an adhesive layer, to which a protective film was bonded, was obtained in the same manner as in Example 1 except that the photopolymerization initiator used for the layer portion-forming photocurable resin composition in Example 1 was changed from 0.3 part by mass of bis(2,4,6-trimethylbenzoyl)-phenylphosphine oxide (IRGACURE 819, manufactured by Ciba Specialty Chemical) to 1 part by mass of 1-hydroxy-cyclohexyl-phenyl-ketone (IRGACURE 184, manufactured by Ciba Specialty Chemical), and the ultraviolet absorber (TINUVIN 109, manufactured by Ciba Specialty Chemical) was not added. This transparent plate L having the adhesive layer was horizontally placed in a constant temperature tank of 80° C., heated for 30 minutes, then taken out and left to stand still at 25° C. for about 1 week. Voids were not observed at the interface between the protective plate A and the adhesive layer.

Then, the transparent plate L having the adhesive layer was left to stand still for 30 minutes in a refrigerator at −20° C. and then taken out, and the protective film was immediately peeled. It was further left to stand still at 25° C. for 1 hour and then, the thicknesses of the seal portion and the layer portion of the adhesive layer were measured by a laser displacement meter and compared, whereby there was a difference in level of about 20 μm in the vicinity of the boundary between the seal portion and the layer portion, and the seal portion was thicker than the layer portion. The thickness of the layer portion was 0.4 mm.

Further, the shearing modulus of the layer portion of the adhesive layer was measured after curing under the same conditions as in the above step (d) and found to be 1.5×10⁵ Pa. The elastic modulus of the seal portion was the same as in Example 1 i.e. 7×10⁵ Pa.

A display device N was obtained by bonding, in a reduced pressure apparatus, the transparent plate L having the adhesive layer, from which the protective film was peeled, to a display panel M taken out from a TV receiver of the same type as the TV receiver from which the display panel G was taken out, in the same manner as in Example 1.

The display device N was left to stand still for 10 minutes and the observed, whereby many tiny voids were observed at the interface between the display panel M and the adhesive layer. The display device N was left to stand for 24 hours and then, observed again, whereby the voids were found to have all disappeared, and a display device N wherein the display panel M and the transparent plate L having the adhesive layer were bonded through the adhesive layer without any defects, was obtained.

The display device N was returned to the housing of the liquid crystal television receiver from which the display panel M was taken out, and the wiring was re-connected, and the television receiver was switched on, whereby a homogeneous good image was obtained, and the display contrast was higher than the initial stage. Even if the image display surface was pressed strongly by a finger, no image distortion was observed, and the transparent plate L having the adhesive layer effectively protected the display panel M.

Instead of the display panel M, a soda lime glass having substantially the same shape as the display panel M and having a thickness of 2 mm was bonded to the transparent plate L having the adhesive layer in the same step as the production of the above display panel, to obtain a laminated member N′. The laminated member N′ was left to stand for 24 hours in the same manner as the display device N, and then the haze value of the light transmitting part of the laminated member N′ was measured and found to be at most 1%, and thus it had good transparency.

### INDUSTRIAL APPLICABILITY

The transparent plate having an adhesive layer of the present invention makes it possible to carry out bonding with another plate (such as a display panel) simply and without remaining the voids at the interface between the adhesive layer and another plate and thus is useful for the production of e.g. a display device having a display panel protected by the transparent plate.

This application is a continuation of PCT Application No. PCT/JP2011/062018, filed May 25, 2011, which is based upon and claims the benefit of priority from Japanese Patent Application 2010-120669 filed on May 26, 2010, Japanese Patent Application No. 2010-184081 filed on Aug. 19, 2010 and Japanese Patent Application No. 2010-184082 filed on Aug. 19, 2010. The contents of those applications are incorporated herein by reference in its entirety.

### REFERENCE SYMBOLS

1: Transparent plate having adhesive layer
2: Display device
10: Protective plate (transparent plate)
14: Adhesive layer
16: Protective film
18: Layer portion
20: Seal portion
22: Uncured seal portion
24: Region
26: Layer portion-forming photocurable resin composition
36: Support plate
50: Display panel

What is claimed is:

1. A transparent plate having an adhesive layer, which comprises a transparent plate and an adhesive layer formed on at least one surface of the transparent plate, wherein the adhesive layer comprises a layer portion spreading over the surface of the transparent plate and a seal portion enclosing the periphery of the layer portion.

2. The transparent plate having an adhesive layer according to claim 1, wherein at least at a part of a region where the seal portion is adjacent to the layer portion, the thickness of the seal portion is thicker than the thickness of the layer portion.

3. The transparent plate having an adhesive layer according to claim 2, wherein the region where the seal portion is adjacent to the layer portion, is a region constituted by the layer portion within the same length as the thickness of the seal portion in a direction parallel to the surface of the transparent plate and vertical to the longitudinal direction of the seal portion, from the plane where the seal portion is in contact with the layer portion.

4. The transparent plate having an adhesive layer according to claim 1, wherein the shearing modulus of the layer portion at 25° C. is from 10³ to 10⁷ Pa.

5. The transparent plate having an adhesive layer according to claim 1, wherein the shearing modulus of the seal portion at 25° C. is larger than the shearing modulus of the layer portion at 25° C.

6. The transparent plate having an adhesive layer according to claim 1, wherein the transparent plate is a protective plate for a display device.

7. The transparent plate having an adhesive layer according to claim 1, which further has a strippable protective film covering the surface of the adhesive layer.

8. A display device comprising:
a display panel, and
the transparent plate having an adhesive layer as defined in claim 1, which is bonded to the display panel so that the adhesive layer is in contact with the display panel.

9. A process for producing the display device as defined in claim 8, which comprises laminating and bonding the display panel and the transparent plate having an adhesive layer so that the adhesive layer is in contact with the display panel, in a reduced pressure atmosphere of at most 1 kPa.

10. A process for producing a transparent plate having an adhesive layer which comprises a transparent plate, an adhesive layer formed on at least one surface of the transparent plate, and a strippable protective film covering the adhesive layer, wherein the adhesive layer comprises a layer portion spreading over the surface of the transparent plate and a seal portion enclosing the periphery of the layer portion, said process comprising the following steps (a) to (e):
(a) a step of applying a liquid seal portion-forming curable resin composition along the periphery of the surface of a transparent plate to form a seal portion,
(b) a step of supplying a liquid layer portion-forming curable resin composition to a region enclosed by the seal portion,
(c) a step of laminating a support plate having a protective film bonded thereto, on the layer portion-forming curable resin composition, in a reduced pressure atmosphere of at most 1 kPa, so that the protective film is in contact with the layer portion-forming curable resin composition, thereby to obtain a laminated member having an uncured layer portion made of the layer portion-forming curable resin composition hermetically sealed by the transparent plate, the protective film and the seal portion,
(d) a step of curing the uncured layer portion in such a state that the laminated member is placed in a pressure atmosphere of at least 50 kPa, to form an adhesive layer comprising the layer portion and the seal portion, and
(e) a step of releasing the support plate from the protective film.

11. The process for producing a transparent plate having an adhesive layer according to claim 10, wherein the viscosity of the seal portion-forming curable resin composition in an uncured state is at least 10 times the viscosity of the layer portion-forming curable resin composition in an uncured state.

12. The process for producing a transparent plate having an adhesive layer according claim 10, wherein the layer portion-forming curable resin composition contains a chain transfer agent.
